(19) United States
(12) Patent Application Publication
(10) Pub. No.: US 2023/0384188 A1
(43) Pub. Date: Nov. 30, 2023

(54) ROOM TEMPERATURE STABLE, DRY BIOLOGICAL TRANSPORT MEDIA

(71) Applicant: GenTegra, LLC, Pleasanton, CA (US)

(72) Inventor: Shanavaz Nasarabadi, Pleasanton, CA (US)

(21) Appl. No.: 18/158,851

(22) Filed: Jan. 24, 2023

Related U.S. Application Data
(63) Continuation of application No. PCT/US21/46973, filed on Aug. 20, 2021.
(60) Provisional application No. 62/706,504, filed on Aug. 20, 2020.

(51) Int. Cl. G01N 1/34

(52) U.S. Cl. CPC G01N 1/34

(57) ABSTRACT

Disclosed are liquid and solid biological transport media for use in the stabilization and storage of biological samples comprising proteins, DNA, and RNA, including viral RNA. Further provided are methods of making and using the transport media, including collection, stabilization, storage, and transport of biological samples in the media. More particularly, a biological transport media is disclosed for use in the stabilization and transport of samples containing SARS-CoV-2 viral material, wherein the media permits direct-to-PCR analysis of the SARS-CoV-2 viral material.

### CROSS-REFERENCE TO RELATED APPLICATIONS

This application is a bypass continuation of PCT/US2021/046973 filed Aug. 20, 2021 which is related to provisional application Ser. No. 62/706,504, filed Aug. 20, 2020, each of which are herein incorporated by reference in their entirety.

### TECHNICAL FIELD

The disclosure relates generally to liquid and solid biological transport media for the stabilization of biological samples comprising proteins, DNA, and RNA, including viral RNA, and more particularly viral RNA from SARS-CoV-2. The disclosure also relates to methods of making and using the media, namely collection, stabilization, storage, and transport of biological samples stabilized in the media. Preferably, the media is room temperature stable and is either a solid or liquid which dries for transport. In a preferred embodiment, the media is direct-to-PCR.

### TECHNICAL BACKGROUND

Effective systems and methods of stabilizing fully intact biological materials from raw samples are critical in performing accurate qualitative testing and analysis. In any form of disease testing, there is a need for assays which provide a high degree of analytical sensitivity and low analytical specificity and further tests which provide high clinical sensitivity and low clinical specificity. Ideally, such assays permit non-or minimally-invasive permit point-of-care testing.

Biological transport media represents one major hurdle in providing such assays and tests. Effective biological transport media compositions must have a long shelf life and remain stable under a variety of temperature, light, and moisture conditions. Importantly, the transport media must provide stability both before and after sample collection. In other words, it is critical that test kits contain media which will not expire before use, even if the time from production to use spans days or months. It is also critical that tests comprise media which can effectively stabilize biological samples under a wide variety of storage and transport conditions and enable a high degree of sample recovery. Without stabilization of a biological sample in a transport media, testing and analysis becomes impossible and/or inaccurate.

Further, transport media must be provided in a form which permits easy collection and easy transportation of many different types of samples. As an example, the pandemic caused by SARS-CoV-2 has illustrated the need for rapid, simple, accurate, specific, and sensitive sample collection and testing, particularly point-of-care testing. Representative biological materials useful in SARS-CoV-2 analysis include saliva, nasopharyngeal secretions, sputum, and fecal matter, among others. Saliva is the preferred form of biological sample collected for rapid point-of-care tests.

Regardless of the particular application, it is highly desirable to store and have access to many biological samples containing raw biological samples in a manner that is stable at room temperature and which is in a container with dry, as opposed to liquid, reagents. Further, stabilization and storage methods must maintain long-term sample integrity to prevent the loss of materials which are often irreplaceable or otherwise difficult to acquire. In order to allow facilities to obtain and store a high volume of nucleic acids, such stabilization and storage means must be easily transportable and allow for a streamlined processing and handling of a high volume of samples, while not requiring complicated and expensive maintenance.

Where point-of-care testing is not, or cannot be conducted, there is often a need to perform PCR testing on the raw samples, but typically the raw samples must be transferred from a storage device to a testing device. This risks contamination and also adds another step to testing process.

Existing methods of stabilizing and storing nucleic acids obtained from raw samples suffer from high cost and/or poor sample integrity. For example, the standard method for storage and preservation of RNA is at ultra-low temperatures, usually through the use of liquid nitrogen and/or freezers. However, shipping samples in this manner is expensive, hazardous, and often results in the samples being subject to high variations in temperature during the shipping process. Alternatively, some existing methods turn to desiccation. Although desiccated samples are less expensive to ship, desiccated samples require extensive laboratory preparation in order to stabilize the samples. This preparation is usually not feasible when the nucleic acids to be stabilized are in a raw sample, i.e. found in saliva collected, as the sample must be stabilized and stored before nucleic acid isolation and additional processing.

It is also a challenge to stabilize proteins (viral, eukaryotic, prokaryotic, etc.). The problem is further exacerbated in nucleic acids, which can degrade very quickly if stored in improper conditions. As a result, it is difficult to effectively stabilize genetic material. RNA, including viral RNA, is especially labile: it can spontaneously degrade even in an aqueous medium. As a result, the storage of RNA—viral and total— poses a significant challenge beyond that of most nucleic acids.

Consequently, there is a need in the field to develop effective DNA, RNA, and protein storage materials and systems which prevent degradation and destabilization of DNA, RNA, and proteins, particularly viral RNA.

There is a need to develop assays which provide a high degree of recovery of biological samples—particularly viral RNA—thus permitting high sensitivity and low specificity disease tests. In particular, there is a need to develop assays amenable to rapid point-of-care testing.

There is also a need to develop biological transport media which are part of a user-friendly testing kit.

There is a still further need to develop biological transport media which permits PCR testing on raw samples, i.e. direct to PCR media.

Other objects, features, and/or advantages will become apparent through the description and examples.

### BRIEF DESCRIPTION OF THE FIGURES

FIG. 1 shows a bar chart of percent recovery of genome equivalents at 25 C, 37 C, 46 C, and 56 C.

FIG. 2 shows a bar chart of percent recovery of genome equivalents at 25 C, 37 C, 46 C, and 56 C.

FIG. 3 shows a bar chart of genome equivalents under a stress study at 25 C, 37 C, 46 C, and 56 C.

FIG. 4A shows a bar chart of percent virus recovery at 25 C.

FIG. 4B shows a bar chart of percent virus recovery at 37 C.

FIG. 4C shows a bar chart of percent virus recovery at 46 C.

FIG. 4D shows a bar chart of percent virus recovery at 56 C.

FIG. 5 shows a graph comparing the genome equivalents with use of UTM versus GTR-VTM at 25 C.

FIG. 6 shows a graph comparing viable genome equivalents stored at 25 C over 10 days.

FIG. 7 shows a graph comparing viable genome equivalents stored at 25 C over days.

FIG. 8 shows a graph comparing viable genome equivalents stored at 25 C over days.

FIG. 9 shows a graph comparing the viable genome equivalents stored at 25 C, 37 C, 46 C, and 56 C over ten days.

FIG. 10 shows a graph comparing the viable genome equivalents stored at 25 C, 37 C, 46 C, and 56 C over ten days.

FIG. 11A shows a black and white photograph from a side view of a saliva collection tube with an example composition disclosed herein.

FIG. 11B shows a black and white photograph from a bottom view of a saliva collection tube with an example composition disclosed herein.

FIG. 12 shows a graph comparing the % virus recovery at 56 C.

FIG. 13A shows a graph Cq/CT values GTR-STM and GTR-VTM at 5 LoD.

FIG. 13B shows a graph Cq/CT values GTR-STM and GTR-VTM at 2 LoD.

FIG. 14 shows a bar chart of the genome equivalents comparing GTR-STM at 25 C and −80 C control over a period of 10 days.

FIG. 15 shows a bar chart of the genome equivalents comparing GTR-STM at 56 C and −80 C control over a period of 6 days.

FIG. 16 shows a graph comparing contrived GTR-VTM versus GTR-STM at 2 LoD with gamma irradiated SARS-CoV-2 virus.

FIG. 17 shows a graph of MagMax RNA extraction from contrived saliva samples with and without GTR-STM spiked with 2 copies per uL of gamma irradiated SARS-CoV-2.

FIG. 18 shows a graph of GTR-STMD samples quantified with N1 primer.

FIG. 19 shows a graph of GTR-STMD samples quantified for RNAse-P CT values.

FIG. 20 shows a graph of direct STMD amplification at 2 LoD, 5 LoD, and 10 LoD.

FIG. 21 shows a graph of direct amplification of NP samples at 2 LoD, 5 LoD, and 10 LoD in GTR-VTMD.

FIG. 22 shows a graph of direct amplification of NP samples in GTR-VTMD contrived with gamma irradiated SARS-CoV-2 virus at 2 LoD.

FIG. 23 shows a bar chart comparing the quantification of VTM and PBS of GTR-STMD samples quantified with N1 primer.

FIG. 24 shows a bar chart comparing RNA extraction from saliva with gamma irradiated SARS-CoV-2 at 2 LoD, 5 LoD, and 10 LoD.

FIG. 25 shows a bar chart comparing GTR-STMD direct, Direct+QIAamp, and QIAamp at 2 LoD, 5 LoD, and 10 LoD.

FIG. 26 shows a bar chart comparing two saliva transport medias to compare stabilization of SARS-CoV-2 at 25 C after 1 day, 2 days, 5 days, and 30 days.

FIG. 27 shows a flow chart for the direct-to-PCR process using the GTR-STMDk media.

FIG. 28 shows a graph comparing average CT values of the direct into PCR amplified product to the average CT value of the GTR-STMdk samples amplified after extraction of RNA.

### DETAILED DESCRIPTION OF THE PREFERRED EMBODIMENTS

The embodiments of this invention are not limited to particular systems and methods for stabilizing and storing raw samples containing nucleic acids, particularly whole blood, and plasma samples, which can vary. It is further to be understood that all terminology used herein is for the purpose of describing particular embodiments only and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers within the defined range. Throughout this disclosure, various aspects of this invention are presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range (e.g. 1 to 5 includes 1, 1.5, 2, 2¾, 3, 3.80, 4, and 5).

So that the present invention may be more readily understood, certain terms are first defined. Unless defined otherwise, all technical and scientific terms used herein have the same meaning as commonly understood by one of ordinary skill in the art to which embodiments of the invention pertain. Many methods and materials similar, modified, or equivalent to those described herein can be used in the practice of the embodiments of the present invention without undue experimentation, the preferred materials and methods are described herein. In describing and claiming the embodiments of the present invention, the following terminology will be used in accordance with the definitions set out below.

The term “about,” as used herein, refers to variation in the numerical quantity that can occur, for example, through typical measuring and liquid handling procedures used for making concentrates or solutions in the real world; through inadvertent error in these procedures; through differences in the manufacture, source, or purity of the ingredients used to make the compositions or carry out the methods; and the like. The term “about” also encompasses amounts that differ due to different equilibrium conditions for a composition resulting from a particular initial mixture. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts.

The term “weight percent,” “wt. %,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt. %,” etc.

The term “analytical sensitivity” refers to an assay's ability to detect very low concentrations of a given substance and is often referred to as the limit of detection (LoD). LoD refers to the actual concentration of an analyte in a specimen that can be consistently detected ≥95% of the time.

The term “analytical specificity” describes an assay's ability to detect only the given substance in a sample matrix without cross reaction with, or interference from, other substances.

“Clinical sensitivity” and “Diagnostic sensitivity” refer to the ability of a test to correctly identify all individuals tested who have a given disease, i.e. true-positive results.

“Clinical specificity” and “Diagnostic specificity” describe the ability of a test to correctly identify all individuals tested who do not have a given disease, i.e. true-negative results.

The terms “point-of-care,” “point-of-care testing” and “POC” as used herein refer generally to the location where a diagnostic test is conducted, specifically a test conducted at, or near the time and place of patient care. POC testing typically occurs outside of a laboratory setting and generally provides rapid results within a matter of minutes or hours.

The terms “cycle threshold value,” “Ct value,” “CT value,” “cycle quantification value,” and “Cq value” refer to the number of cycles required for the fluorescent signal in a real time PCR assay to cross the threshold (i.e. exceed background levels). In a real time PCR assay, a positive reaction is detected by the accumulation of a fluorescent signal. CT levels are inversely proportional to the amount of target nucleic acid in the sample (i.e. the lower the CT level, the greater the amount of target nucleic acid in the sample). Generally, CTs of ≤29 are strong positive reactions indicating abundant quantities of the target nucleic acid in the sample, while CTs of about 30-37 are positive reactions indicative of moderate amounts of the target nucleic acid, and CTs of 38-40 are weak reactions indicating minimal amounts of target nucleic acid and/or high environmental contamination. A rejection threshold can be developed from the CT value of a control sample. In the instant case, a rejection threshold of (CTCtrl+3) was used based on the CT values of the −80° C. control sample values. Samples where the ratio CT/(CTCtrl+3)>1 surpassed the rejection threshold were considered no longer viable because they have degraded beyond usability. Further methods for discerning analytical specificity and sensitivity and the threshold value for SARS-CoV-2 can be found in the World Health Organization's summary document of available SARS-CoV-2 protocols, which is herein incorporated by reference in its entirety and can be found at https://www.who.int/docs/default-source/coronaviruse/whoinhouseassays.pdf?sfvrsn=de3a76aa 2.

The terms “nucleic acid,” “oligonucleotide” and “polynucleotide” may be used interchangeably and encompass DNA, RNA, cDNA, whether single stranded or double stranded, as well as chemical modifications thereof and artificial nucleic acids (e.g., PNA, LNA, etc.). The source of the nucleic acids may vary, including but not limited to RNA derived from whole blood and plasma, especially viral RNA.

The terms “polypeptide,” “peptide,” and “protein” are used interchangeably herein to refer to a polymer of amino acid residues.

The terms “residue” or “amino acid residue” or “amino acid” are used interchangeably herein to refer to an amino acid that is incorporated into a protein, polypeptide, or peptide (collectively “protein”). The amino acid may be a naturally occurring amino acid and, unless otherwise limited, may encompass known analogs of natural amino acids that can function in a similar manner as naturally occurring amino acids.

The terms “matrix,” “dry state,” and “solid-state matrix” as used herein refer to cellulose paper that has been impregnated with the stabilizing solution according to the present application.

The terms “stabilize” and “preserve” as used herein mean to render resistant to hydrolytic damage, oxidative damage, irreversible denaturation (unfolding or loss of secondary or tertiary structure), mechanical damage due to shearing or other force, and other damage. This resistance to damage also results in a retention of function and maintenance of integrity of a sample. Retention of function which is preserved and stabilized may include, without limitation, a pair of forward and reverse primers retaining their ability to prime amplification of a target polydeoxyribonucleotide or a target nucleic acid (e.g., genetic) locus; a reverse transcription primer retaining its ability to prime reverse transcription of a target polyribonucleotide; a biological sample retaining its biological activity or its function as an analyte in an assay, or components in the biological sample retaining their biological activity or their function as analytes in an assay; and bacterial cells retaining their infectivity in an appropriate medium (e.g., an agar medium or a fluid culture), or viral particles retaining their infectivity in an appropriate medium (e.g., a natural fluid or a laboratory cell culture).

As used herein, the terms “raw sample,” “raw material,” “whole sample” and “whole material” refer to a basic substance in its natural, modified, or semi-processed state wherein the material is not yet fully processed or prepared, including, but not limited to whole blood, plasma, saliva, and other bodily fluids. The raw samples of the present application generally contain wholly or a high quantity of intact cells, i.e. cells that have not yet been intentionally lysed. Although some cells in a raw sample may be ruptured due to natural causes or the state of the sample upon collection, a raw sample according to the present application does not contain cells intentionally ruptured, or otherwise processed or prepared.

As used herein, the term “lysis” refers to the breaking down of the cell, often by viral, enzymatic, or osmotic reactions that comprises cell wall integrity. Cell lysis is used to break open cells to avoid shear forces that would otherwise denature or degrade sensitive proteins, DNA, RNA, and other components.

As used herein, the term “whole blood” means blood having none of the constituent components removed or intentionally separated. Whole blood contains, for example, red cells, white cells, and platelets suspended in blood plasma. Whole blood generally comprises approximately 55% plasma, 45% red blood cells, and <1% white blood cells and platelets. The whole blood may include components endemic to whole blood, and the whole blood may also include components nonnative to whole blood, including but limited viral, bacterial, pharmaceutical or other microorganism material such as HIV, hepatitis B, hepatitis C, etc.

As used herein, the term “plasma” references the liquid portion of blood which, when part of whole blood, suspends red and white blood cells and platelets. Blood plasms generally contains about 92% water, 7% vital proteins (e.g. albumin, gamma globulin, and anti-hemophilic factor), and 1% mineral salts, sugars, fats, hormones, and vitamins. The term “plasma” as used herein can refer to plasma occurring as part of whole blood, and/or it can refer to plasma separated from whole blood. The term “plasma” also encompasses all plasma derivatives, whether the derivatives occur within the plasma or have been separated from the plasma via fractionation. The plasma derivatives may be components endemic to plasma, including but not limited to Factor VIII Concentrate, Factor IX Concentrate, Anti-Inhibitor Coagulation Complex (AICC), Albumin, Immune Globulins, Anti-Thrombin III Concentrate, Alpha 1-Proteinase Inhibitor Concentrate. The plasma derivatives may also be components nonnative to plasma, including but limited viral, bacterial, pharmaceutical, or other microorganism material such as HIV, hepatitis B, hepatitis C, etc. Plasma may further include circulating RNA and other circulating genetic or other biomarker materials.

As used herein, the terms ambient temperature” or “room temperature” refers to a temperature range from about 18° C. to about 27° C., or from about 20° C. to about 25° C., or from about 22° C. to about 40° C. In other embodiments, the term “ambient temperature” or “room temperature” refers to a temperature of about 18° C., 19° C., 20° C., 21° C., 22° C., 23° C., 24° C., 25° C., 26° C. or 27° C. In certain embodiments, the term “ambient temperature” or “room temperature” refers to a temperature of about 22° C., 37° C., 39° C. or 42° C.

The compositions of the present application may be used to stabilize and store one or more raw samples, including, but not limited to, whole blood, plasma, saliva, or other bodily fluids. The compositions of the present application are capable of inhibiting and/or mitigating undesirable contact between the raw sample (and components therein) and various contaminants or potential sources of degradation. These compositions are preferably useful for storing and testing raw samples for viruses, bacteria, or other illnesses or infections. The viruses, bacteria, illnesses, and infections which may be tested are not limited by the compositions. Viruses can include enveloped and non-enveloped viruses, corona viruses (including, but not limited to, COVID-19).

In some embodiments, the compositions of the present application are inert with respect to the raw samples (and components therein). As used herein, “inert” means that the inorganic compound either does not bind to one or more types of samples or binds reversibly such that the raw samples are not degraded as a result of such binding. Further, in an embodiment, the compositions of the present application are inert with respect to one or more downstream methods that may be used to analyze the raw samples and components therein. In this context, “inert” means that the presence of the compositions of the present application together with a raw sample does not reduce the rate of the downstream methods of analysis by more than 50% and does not significantly reduce the fidelity of the method. Exemplary methods of analysis may include, without limitation, nucleic acid transcription and/or amplification (e.g., reverse transcription, PCR, real time PCR, etc.), endonuclease digestion (e.g., reactions involving type II endonucleases, such as EcoRI, BamHI, HindIII, NotI, SmaI, BglII, etc.), cloning techniques (e.g., ligation), protein digestion (e.g., reactions involving proteinases such as proteinase K, trypsin, chymotrypsin, savinase, etc.), microarray analysis (e.g., of nucleic acids or proteins), immunoassays (e.g., immunoprecipitation, ELISA, etc.), mass spectroscopy, or any combination thereof. In certain embodiments, the inorganic compound is inert upon dilution (e.g., dilution by a factor of 2, 3, 4, 5, 6, 7, 8, 9, 10, 15, 20, or more).

In an embodiment, the components in the composition of the present application may also be water soluble. As used herein in this context, “water soluble” means that the inorganic compound has a solubility in water, at 25° C., of 1.0 mg/ml or greater. In certain embodiments, the inorganic compound has a solubility in water, at 25° C., of at least 1.5 mg/ml, 2.0 mg/ml, 3.0 mg/ml, 4.0 mg/ml, 5.0 mg/ml, 7.5 mg/ml, 10 mg/ml, 15 mg/ml, 20 mg/ml, 25 mg/ml, 30 mg/ml, 35 mg/ml, 40 mg/ml, 50 mg/ml, 60 mg/ml, 70 mg/ml, 80 mg/ml, 90 mg/ml, 100 mg/ml, 125 mg/ml, 150 mg/ml, 200 mg/ml, or greater. In certain embodiments, the inorganic compound can be easily solubilized in water. For example, in certain embodiments, the inorganic compound can be solubilized in water, at 25° C., in 75, 60, 50, 40, 30, 25, 20, 15, 10, 9, 8, 7, 6, 5, 4, 3, 2, or fewer minutes. In other embodiments, the inorganic compound can be solubilized in water, at 25° C., in 7, 6, 5, 4, 3, 2, 1.5, or fewer hours. In certain embodiments, the inorganic compound can be solubilized in water, at 25° C., with or without the use of agitation (e.g., pipetting, shaking, or vortexing).

Exemplary, non-limiting, compositions are described below in Tables 1 and 2. In particular, as shown in Table 1, the compositions may be expressed in terms of percentage, based on the total percentage of the composition.

TABLE 1

| | Exemplary | Exemplary | Exemplary |
|---|---|---|---|
| | Range 1 | Range 2 | Embodiment |
| Component | (% Total) | (% Total) | (% Total) |
| pH Buffer/Adjuster | 1-10% | 2-5% | 4% |
| Hydroxyl/Oxygen | 15-35% | 20-30% | 27% |
| Radical Scavenger(s) | | | |
| Metal Chelator | 5-25% | 10-20% | 16% |
| Reducing Agent | 15-30% | 20-27% | 24% |
| Inhibitor | 0.1-5% | 0.5-1.5% | 1% |
| Stabilizer | 35-55% | 40-45% | 42% |
| Antimicrobial Agent | 0.5-10% | 1-5% | 2% |
| Water | 20-80% | 35-55% | 42% |
| Final Vol. | 91.6%-250% | 128.5%-188.5% | 158% |

The weight percentages of Table 1 may be useful in preparing large quantities of the compositions. However, the compositions may also be expressed in terms of quantities relative to a 1 mL sample, the amount of the composition suitable for one swab sample, such as outlined in Table 2.

TABLE 2

| Component | Per mL | Units | Final Mg | Units |
|---|---|---|---|---|
| pH Buffer/Adjuster | 43.06 | mg | 35.883 | mg |
| First Hydroxyl/Oxygen Radical | 19.26 | mg | 16.050 | mg |
| Scavenger | | | | |
| Second Hydroxyl/Oxygen Radical | 90 | mg | 75.000 | mg |
| Scavenger | | | | |
| Metal Chelator | 193.8 | mg | 161.500 | mg |
| Reducing Agent | 288 | mg | 240.000 | mg |
| Inhibitor | 12.67 | mg | 10.558 | mg |
| Water | 500 | uL | 416.667 | uL |
| Stabilizer | 500 | uL | 416.667 | uL |
| Antimicrobial Agent | 22 | mg | 18.333 | mg |
| Third Hydroxyl/Oxygen Radical | 200 | uL | 166.667 | uL |
| Scavenger | | | | |

Preferably, the compositions are room temperature stable and provide room temperature storage stability for raw samples. Further, the compositions are preferably dry (i.e., dry materials not in a liquid state). In a preferred embodiment, the compositions can be direct-to-PCR, meaning that raw samples stored on the compositions can be tested via PCR without need to transfer from the storage device to test container or test composition. In a further aspect, the composition inactivates contaminating RNases.

Collecting and transporting samples using the compositions described herein can completely eliminate the need for cold chain transportation and storage, significantly reducing cost and the potential negative effects of RNA degradation. As an example, to support expansion of COVID-19 diagnostic testing, the compositions may be used as a specific viral collection and transport media for saliva samples. The compositions described herein beneficially facilitate the adoption of saliva as a routine sample type, improve the quality of test results through better sample integrity, and positively impact laboratory workflows by eliminating labor intensive steps in PCR sample preparation.

### Compositions

In some embodiments, the compositions include one or more hydroxyl oxygen scavengers and/or oxygen radical scavengers, a pH buffer or adjuster, a metal chelator, a reducing agent, an inhibitor, a stabilizer, and an antimicrobial agent. In an aspect, the composition further comprises a solvent, such as water. In a further aspect, the composition is free of guanidinium, making it compatible with lab automation and self-sterilizing PCR instrumentation.

### pH Buffers/Adjusters

In some embodiments, the compositions include one or more pH buffers/adjusters. The pH buffers/adjusters may be used to modify and/or maintain the pH of the composition and in doing so act as a precipitating agent. In some embodiments, the pH buffer is any of a large number of compounds known in the art for their ability to resist changes in the pH of a solution, such as an aqueous solution, in which the pH buffer is present. Selection of one or more particular pH buffers for inclusion in a stable storage composition may be done based on the present disclosure and according to routine practices in the art, and may be influenced by a variety of factors including the pH that is desirably to be maintained, the nature of the sample to be stabilized, the solvent conditions to be employed, the other components of the formulation to be used, and other criteria. For example, typically a pH buffer is employed at a pH that is within about 0.1, 0.2, 0.3, 0.4, 0.5, 0.6, 0.7, 0.8, 0.9 or 1.0 pH unit of a proton dissociation constant (pKa) that is a characteristic of the buffer.

Examples of suitable pH buffers include, without limitation, pH buffers include citric acid, tartaric acid, malic acid, sulfosalicylic acid, sulfoisophthalic acid, oxalic acid, borate, CAPS (3-(cyclohexylamino)-1-propanesulfonic acid), CAPSO (3-(cyclohexylamino)-2-hydroxy-1-propanesulfonic acid), EPPS (4-(2-hydroxyethyl)-1-piperazinepropanesulfonic acid), HEPES (4-(2-hydroxyethyl)piperazine-1-ethanesulfonic acid), MES (2-(N-morpholino)ethanesulfonic acid), MOPS (3-(N-morpholino)propanesulfonic acid), MOPSO (3-morpholino-2-hydroxypropanesulfonic acid), PIPES (1,4-piperazinediethanesulfonic acid), TAPS (N[tris(hydroxymethyl)methyl]-3-aminopropanesulfonic acid), TAPSO (2-hydroxy-3-[tris(hydroxymethyl)methylamino]-1-propanesulfonic acid), TES (N-[tris(hydroxymethyl)methyl]-2-aminoethanesulfonic acid), bicine (N,N-bis(2-hydroxyethyl)glycine), tricine (N-[tris(hydroxymethyl)methyl]glycine), tris (tris(hydroxymethyl)aminomethane), bis-tris (2-[bis(2-hydroxyethyl)amino]-2-(hydroxymethyl)-1,3-propanediol), 5-(4-dimethyl)amino benzylidene rhodanine, sulfosalicylic acid, lithium chloride, and lithium hydroxide, and/or lithium dodecyl sulfate. In a preferred embodiment, the pH buffer/adjuster is lithium hydroxide and/or lithium dodecyl sulfate.

With the use of a pH buffer/adjuster, the compositions may have a pH of about 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9 or 9.0. In an aspect, the pH buffer/adjuster may be present in the composition in an amount of from about 1% to 10% of the composition, including 2%, 3%, 4%, 5%, 6%, 7%, 8%, 9%, and 10%, inclusive of all integers (e.g. fractions, decimals) within this range. In a further aspect, the pH buffer/adjuster may be present in the composition in an amount of from about 10 mg/mL to about 60 mg/mL, including 15 mg/mL, 20 mg/mL, 25 mg/mL, 30 mg/mL, 35 mg/mL, 40 mg/mL, 45 mg/mL, 50 mg/mL, 55 mg/mL, and 60 mg/mL, inclusive of all integers (e.g. fractions, decimals) within this range, such as 43 mg/mL, 35 mg/mL, etc.

### Hydroxyl Radical Scavenger/Oxygen Radical Scavenger

The compositions may include one or more hydroxyl radical scavengers/oxygen radical scavengers. In an embodiment, the compositions include at least two hydroxyl radical scavengers/oxygen radical scavengers. In a further embodiment, the compositions include at least three hydroxyl radical scavengers/oxygen radical scavengers. These scavengers are capable of inhibiting undesirable contact between the raw sample (and components therein) and various contaminants or potential sources of degradation. Hydroxy radical scavengers can in particular protect against the effects of oxygen.

Examples of suitable hydroxyl radical scavengers include, but are not limited to mannitol (including D-mannitol) and other sugar alcohols such as erythritol, sorbitol and xylitol, azides, cysteine, including L-cysteine, N-Acetyl Cysteine etc., lithium dodecyl sulfate (LiDS), dimethylsulfoxide, histidine, salicylic acid, salicylate, monosaccharides, disaccharides (e.g., cellobiose, lactose, maltose, sucrose, and trehalose), complex sugars, and analogs, derivatives and salts thereof.

Examples of suitable oxygen radical scavengers include, but are not limited to, sugar alcohols (e.g., erythritol, mannitol, sorbitol, and xylitol), monosaccharides (e.g., hexoses, allose, altrose, fructose, fucose, fuculose, galactose, glucose, gulose, idose, mannose, rhamnose, sorbose, tagatose, talose, pentoses, arabinose, lyxose, ribose, deoxyribose, ribulose, xylose, xylulose, tetroses, erythrose, erythrulose, and threose), disaccharides (e.g., cellobiose, lactose, maltose, sucrose, and trehalose), complex sugars (e.g., trisaccharides, kestose, isomaltotriose, maltotriose, maltotriulose, melezitose, nigerotriose, raffinose, tetrasaccharides, stachyose, fructo-polysaccharides, galacto-polysaccharides, mannan-polysaccharides, gluco-polysaccharides, glycogen, starch, amylose, amylopectin, dextrin, cellulose, glucans, beta-glucans, dextran, fructans, inulin, glucosamine polysaccharides, chitin, aminoglycosides, apramycin, gentamycin, kanamycin, netilmicin, neomycin, paromomycin, streptomycin, tobramycin, glycosaminoglycans (mucopolysaccharides), chondroitin sulfate, dermatan sulfate, keratan sulfate, heparin, heparan sulfate, and hyaluronan), and analogs, derivatives and salts thereof.

The oxygen radical scavenger/hydroxyl radical scavenger is present in the compositions in a total amount of from about 10% to about 40% of the total composition, including 15%, 20%, 25%, 30%, 35%, and 40%, inclusive of all integers within this range. In a further aspect, the oxygen radical scavenger/hydroxyl radical scavenger is present in a total amount of between about 100 mg/mL to about 500 mg/mL, including 150 mg/mL, 200 mg/mL, 250 mg/mL, 300 mg/mL, 350 mg/mL, 400 mg/mL, 450 mg/mL, and 500 mg/mL, inclusive of all integers within this range.

In a still further aspect, the compositions include at least three oxygen radical scavengers/hydroxyl radical scavengers, wherein the first oxygen radical scavenger/hydroxyl radical scavenger is present in an amount of between about 15 mg/mL to about 30 mg/mL, wherein the second oxygen radical scavenger/hydroxyl radical scavenger is present in an amount of between about 75 mg/mL to about 125 mg/mL, and wherein the third oxygen radical scavenger/hydroxyl radical scavenger is present in an amount of between about 175 mg/mL to about 225 mg/mL, inclusive of all integers within these cited ranges.

### Metal Chelator

In some embodiments, the compositions contain one or more metal chelators. In an embodiment, the composition contains two or more metal chelators. As used herein, a “metal chelator” is a compound that forms two or more bonds with a single metal ion. In certain embodiments, the one or more metal chelators chelate at least one type of metal ion selected from the group consisting of magnesium ions, chromium ions, manganese ions, iron ions, cobalt ions, nickel ions, copper ions, zinc ions, lead ions, or any combination thereof. In certain embodiments, the one or more metal chelators chelate at least one type of metal ion and inhibit metal-dependent reactions between such ions and raw sample present in the composition. In certain embodiments, the one or more metal chelators chelate at least one type of metal ion and prevent such ions from degrading the raw sample (i.e. cells, components within the cells such as nucleic acids, and other materials of the raw sample) present in the composition. In preferred embodiments, the one or more metal chelators chelate magnesium ions and/or manganese ions and inhibit metal dependent reactions between such ions and biomolecules present in the composition. In other preferred embodiments, the one or more metal chelators chelate magnesium ions and/or manganese ions and prevent such ions from degrading biomolecules present in the composition.

Examples of suitable metal chelators include without limitation boric acid, aurintricarboxylic acid (ATA) and salts thereof [e.g., triammonium aurintricarboxylate (aluminon)], borate, citric acid, citrate, salicylic acid, salicylate, 1,2-bis(o-aminophenoxy)ethane-N,N,N′,N′-tetraacetic acid (BAPTA), diethylene triamine pentaacetic acid (DTPA), ethylenediaminetetraacetic acid (EDTA), ethylene glycol tetraacetic acid (EGTA), glycoletherdiaminetetraacetic acid (GEDTA), N-(2-hydroxyethyl)ethylenediamine-N,N′,N′-triacetic acid (HEDTA), nitrilotriacetic acid (NTA), 2,2′-bipyridine, o-phenanthroline, triethanolamine, and analogs, derivatives and salts thereof.

In an aspect, the compositions include one or more metal chelators in an amount of between about 1% to about 35% of the composition, including 5%, 10%, 15%, 20% 25%, 30%, and 35% by weight of the total composition, inclusive of integers within this range. In a further aspect, the compositions include one or more metal chelators in an amount of between about 100 mg/mL to about 300 mg/mL, including 125 mg/mL, 150 mg/mL, 175 mg/mL, 200 mg/mL, 225 mg/mL, 250 mg/mL, 275 mg/mL, and 300 mg/mL, inclusive of all integers within this range.

### Reducing Agents

The compositions may also comprise a reducing agent. Examples of suitable reducing agents include, but are not limited to, cysteine and mercaptoethylene. Examples of reducing agents include, but are not limited to, EDTA, EGTA, o-phenanthroline, dithionite, dithioerythritol, dithiothreitol (DTT), dysteine, 2-mercaptoethanol, mercaptoethylene, bisulfite, sodium metabisulfite, pyrosulfite, pentaerythritol, thioglycolic acid, citrate, urea, uric acid, vitamin C, vitamin E, superoxide dismutases, and analogs, derivatives and salts thereof.

In an embodiment, the compositions may include a reducing agent in an amount of between about 10% to about 50%, including 15%, 20%, 25%, 30%, 35%, 40%, 45%, and 50% of the composition, inclusive of all integers within this range. In a further aspect, the compositions may include a reducing agent in an amount of between about 100 mg/mL to about 400 mg/mL, including 150 mg/mL, 200 mg/mL, 250 mg/mL, 300 mg/mL, 350 mg/mL, 400 mg/mL, 450 mg/mL, and 500 mg/mL, inclusive of all integers within this range.

### Inhibitors

The compositions may further comprise one or more RNase and/or DNase inhibitors. Suitable inhibitors may include, without limitation, aurintricarboxylic acid (ATA) and salts thereof [e.g., triammonium aurintricarboxylate (aluminon)], boric acid, borate, citric acid, citrate, salicylic acid, salicylate, 1,2-bis(o-aminophenoxy)ethane-N,N,N′,N′-tetraacetic acid (BAPTA), diethylene triamine pentaacetic acid (DTPA), ethylenediaminetetraacetic acid (EDTA), ethylene glycol tetraacetic acid (EGTA), glycoletherdiaminetetraacetic acid (GEDTA), N-(2-hydroxyethyl)ethylenediamine-N,N′,N′-triacetic acid (HEDTA), nitrilotriacetic acid (NTA), 2,2′-bipyridine, o-phenanthroline, triethanolamine, mammalian ribonuclease inhibitor proteins [e.g., porcine ribonuclease inhibitor and human ribonuclease inhibitor (e.g., human placenta ribonuclease inhibitor and recombinant human ribonuclease inhibitor adenosine 5′-pyrophosphate, 2′-cytidine monophosphate free acid (2′-CMP), 5′-diphosphoadenosine 3′-phosphate (ppA-3′-p), 5′-diphosphoadenosine 2′-phosphate (ppA-2′-p), leucine, oligovinysulfonic acid, poly(aspartic acid), tyrosine-glutamic acid polymer, 5′-phospho-2′-deoxyuridine 3′-pyrophosphate P′—>5′-ester with adenosine 3′-phosphate (pdUppAp), and analogs, derivatives and salts thereof.

In an embodiment, the compositions may include one or more inhibitors in an amount of between about 0.1% to about 10%, including 0.5%, 1%, 2%, 3%, 4%, 5%, 6%, 7%, 8%, 9%, and 10% of the composition, inclusive of all integers within this range. In a further aspect, the compositions may include one or more inhibitors in an amount of between about 5 mg/mL to about 25 mg/mL, including 10 mg/mL, 15 mg/mL, 20 mg/mL, and 25 mg/mL, inclusive of all integers within this range.

### Stabilizer

The compositions may include one or more stabilizers. As used herein, a “stabilizer” is any agent capable of protecting nucleic acids, particularly nucleic acids occurring in a raw sample, from damage during storage. This may include without limitation, for example circulating RNA, viral RNA, DNA, and others.

In an embodiment the stabilizer comprises a cell separation reagent. In a preferred embodiment, the cell separation reagent is polyethylene glycol. Suitable examples of cell separation reagents include, without limitation, polyethylene glycol 200 (PEG 200), polyethylene glycol 300 (PEG 300), polyethylene glycol 400 (PEG 400), polyethylene glycol 540 (PEG 540), polyethylene glycol 600 (PEG 600), polyethylene glycol 1000 (PEG 1000), polyethylene glycol 1450 (PEG 1450), polyethylene glycol 3350 (PEG 3350), polyethylene glycol 4000 (PEG 4000), polyethylene glycol 4600 (PEG 4600), polyethylene glycol 8000 (PEG 8000), Carbowax MPEG 350, Carbowax MPEG 550, Carbowax MPEG 750, and others.

In an aspect, the compositions include one or more stabilizers in an amount of between about 30% to about 60% of the composition, including 35%, 40%, 45%, 50%, 55%, and 60% of the total composition, inclusive of all integers within this range. In a further aspect, the compositions include on one or more stabilizers in an amount of between about 100 mg/mL to about 300 mg/mL, including 150 mg/mL, 200 mg/mL, 250 mg/mL, and 300 mg/mL, inclusive of all integers within this range.

### Antimicrobial Agent

The compositions may further comprise a microbiocidal or antimicrobial agent. As used herein, an “antimicrobial agent” is any compound that slows or stops the growth of a microorganism. In certain embodiments, the inorganic compound kills one or more microbial organism, such as a bacterium, protist, and/or fungus. In certain embodiments, the inorganic compound inhibits the growth of one or more microbial organism, such as a bacterium, protist, virus, or fungus. Suitable antimicrobial agents may include, without limitation, penicillin, cephalosporin, ampicillin, amoxycillin, aztreonam, clavulanic acid, imipenem, streptomycin, gentamycin, vancomycin, clindamycin, polymyxin, erythromycin, bacitracin, amphotericin, nystatin, rifampicin, tetracycline, chlortetracycline, doxycycline, chloramphenicol, ammolfine, butenafine, naftifine, terbinafine, ketoconazole, fluconazole, elubiol, econazole, econaxole, itraconazole, isoconazole, imidazole, miconazole, sulconazole, clotrimazole, enilconazole, oxiconazole, tioconazole, terconazole, butoconazole, thiabendazole, voriconazole, saperconazole, sertaconazole, fenticonazole, posaconazole, bifonazole, flutrimazole, nystatin, pimaricin, amphotericin B, flucytosine, natamycin, tolnaftate, mafenide, dapsone, caspofungin, actofunicone, griseofulvin, potassium iodide, Gentian Violet, ciclopirox, ciclopirox olamine, haloprogin, silver sulfadiazine, undecylenate, undecylenic acid, undecylenic alkanolamide, Carbol-Fuchsin, nevirapine, delavirdine, efavirenz, saquinavir, ritonavir, indinavir, nelfinavir, amprenavir, zidovudine (AZT), stavudine (d4T), lamivudine (3TC), didanosine (DDI), zalcitabine (ddC), abacavir, acyclovir, penciclovir, valacyclovir, ganciclovir, Rutin, Tannic acid, Direct Red 80, Purpurin compounds and analogs, derivatives and salts thereof.

In an aspect, the compositions include one or more antimicrobial agents in an amount of between about 0.1% to about 25% of the composition, including 1%, 5%, 10%, 15%, 20%, and 25% of the total composition, inclusive of all integers within this range. In a further aspect, the compositions include on one or more antimicrobial agents in an amount of between about 10 mg/mL to about 30 mg/mL, including 15 mg/mL, 20 mg/mL, mg/mL, and 30 mg/mL, inclusive of all integers within this range.

### Serine Protease

In an embodiment, the compositions optionally further comprise a serine protease capable of cleaving peptide bonds in proteins. The serine protease beneficially digests contaminating proteins and removes contamination from preparations of nucleic acid. It also degrades nucleases that can be present during DNA extraction and further protects the nucleic acids from nuclease attack by rapidly inactivating the nucleases that might otherwise degrade the DNA (or RNA).

In an embodiment, the serine protease is broad spectrum. In a preferred embodiment, the serine protease is Proteinase K. The quantity of serine protease depends on the form of the composition (e.g. dry or liquid). When present, compositions include a serine protease in an amount of between about 5 ug and about 100 ug, between about 2 mg/mL to about 40 mg/mL, and/or between about 1 uL to about 50 uL, inclusive of all integers within these ranges.

### Additional Ingredients

In addition to the aforementioned components, the compositions may further include other suitable ingredients, such as a singlet oxygen quencher, a plasticizer, a preservative, a hydroperoxide removing agent (including, but not limited to catalase, pyruvate, glutathione, and/or glutathione peroxidases), an organic or inorganic dye, a detergent, a further buffering agent or plasticizer, an excipient, a bulking agent, a dispersion agent, a solubilizer, a solidification aid, or any combination thereof.

A singlet oxygen quencher is capable of inhibiting undesirable contact between the raw sample (and components therein) and various contaminants or potential sources of degradation. Singlet oxygen quenchers can in particular protect against the effects of oxygen. Examples of suitable singlet oxygen quenchers include, but are not limited to, alkyl imidazoles (e.g., histidine, L-camosine, histamine, imidazole 4-acetic acid), indoles (e.g., tryptophan and derivatives thereof, such as N-acetyl-5-methoxytryptamine, N-acetylserotonin, 6-methoxy-1,2,3,4-tetrahydro-beta-carboline), sulfur-containing amino acids (e.g., methionine, ethionine, djenkolic acid, lanthionine, N-formyl methionine, felinine, S-allyl cysteine, L-selenocysteine, S-[2-(4-pyridyl)ethy]-L-cysteine, S-diphenylmethyl-L-cysteine, S-trityl-homocysteine, L-cysteine, N-acetyl-cysteine, S-ally-L-cysteine sulfoxide, S-aminoethyl-L-cysteine), phenolic compounds (e.g., tyrosine and derivatives thereof), aromatic acids (e.g., ascorbate, salicylic acid, and derivatives thereof), azides such as sodium azide, tocopherol and related vitamin E derivatives, and carotene and related vitamin A derivatives.

As used herein, a “plasticizer” is any agent capable of facilitating or improving the storage function of a dry-state matrix. Thus, in certain embodiments, the plasticizer improves the mechanical properties of a dry-state matrix. In certain embodiments, the plasticizer improves the durability, including resistance to vibrational and other damage, of a dry-state matrix. In certain embodiments, the plasticizer facilitates the reversible dissociation between inorganic compounds and raw sample upon re-hydration of a dry-state matrix. In other embodiments, the plasticizer facilitates the reversible dissociation between stabilizers and raw sample upon re-hydration of a dry-state matrix. Suitable plasticizers may include polyols such as long-chain polyols, short-chain polyols, and sugars. The plasticizer may include, without limitation, polyvinyl alcohol, polyserine, monosaccharides, disaccharides, complex sugars, ethylene glycol, 1-3 propane diol, glycerol, butane triol (e.g., n-butane triol or isobutane triol), erythritol, pentane triol (e.g., n-pentane triol or isopentane triol), pentane tetraol (e.g., n-pentane tetraol, isopentane tetraol), pentaerythritol, xylitol, sorbitol and mannitol.

### Raw Sample Material

The raw sample according to the present application generally contains wholly or a high quantity of intact cells, i.e. cells that have not yet been intentionally lysed. Although some cells in a raw sample may be ruptured due to natural causes or the state of the sample upon collection, a raw sample according to the present application does not contain cells intentionally ruptured, or otherwise processed or prepared.

The source of the raw sample may comprise, without limitation, a biological fluid, a biological suspension, a fluid aspirate, blood, plasma, serum, lymph, cerebrospinal fluid, gastric fluid, bile, perspiration, ocular fluid, tears, oral fluid, sputum, saliva, a buccal sample, a tonsil sample, a nasal sample, mucus, a nasopharyngeal sample, semen, urine, a vaginal sample, a cervical sample, a rectal sample, a fecal sample, a wound or purulent sample, hair, a tissue, a tissue homogenate, cells, a cellular lysate, a tissue or cell biopsy, skin cells, tumor or cancer cells, a microbe, a pathogen, a bacterium, a fungus, a protozoan or a virus, or any combination thereof. Preferably the raw sample comprises DNA, RNA, and/or proteins, including nucleic acids such as single-stranded and double-stranded polynucleotides containing RNA nucleotides and/or DNA nucleotides.

In a preferred embodiment, the sample is a nasopharyngeal swab sample, fecal sample, sputum sample, and/or a saliva sample.

In an embodiment, the raw sample is contained within and/or bound by the compositions. In some embodiments, at least about 50%, 60%, 70%, 80%, 90%, 95%, 99% or 100% of the raw sample by mass is contained within and/or bound by the compositions. The raw sample contained within and/or bound by the composition of the present application may be stored in a closed container (e.g., a capped tube, vial or well) at a temperature from about −80° C. to about 40° C. for at least about 1 day, 3 days, week, 2 weeks, 3 weeks, 1 month, 2 months, 3 months, 4 months, 1 year, 1.5 years or 2 years.

Surprisingly, raw samples stored and preserved using the compositions are highly resistant to hydrolytic damage, oxidative damage, denaturation (e.g., irreversible unfolding or irreversible loss of secondary structure or tertiary structure), and other mechanical damage. Further, unexpectedly, the raw samples stored have a high retention of function/activity.

### Form of the Composition

In an embodiment, the composition is directly added to a raw sample (or vice versa), raw sample/liquid mixture, or present in a collection vessel prior to collection of the raw sample or raw sample/liquid mixture. In some embodiments, the composition added to a raw sample, raw sample/liquid mixture, or other type of raw sample fully solidifies. In some embodiments, composition together with raw sample is fully solidified into a matrix. In other embodiments, the composition added to a raw sample, raw sample/liquid mixture, or other type of raw sample only solidifies partially. The partially solidified composition together with raw sample may form a matrix.

In another embodiment, the composition may be delivered in pre-measured aliquots loaded into sample collection vessels and/or wells, to which an appropriate volume of the raw sample may be added. In such a circumstance, the collection vessels and/or wells are agitated to aid in the even distribution and dispersal of both the composition of the present application and the raw sample.

In a further embodiment, a vial for collecting raw samples can be supplied with pre-measured aliquots of the composition of the present application; an appropriate volume of the raw sample may be subsequently added. Much like the collection vessels and/or wells, the vial is then agitated.

In a still further embodiment, the composition of the present application is provided as part of a kit for collecting samples. The kit may comprise a composition according to the present application, a raw sample, a carrier comprising a container or solid support for the composition and raw sample, and instructions for using the kit for the stabilization and storage of a given raw sample. In an embodiment, the carrier comprises a saliva collection tube, a vial, a collection cup, a corrugated jar, a container jar, a collection tube, an absorbent pouch, and/or a collection tube comprising a swab.

The kits according to the present application may be adapted for shipment by mail. For example, in addition to the composition, raw sample, carrier, and instructions, the kit may comprise closures for closing/sealing the carrier from contamination (such as tape, a sealable bag, a cap, a stopper, or other sealant material), an additional container (comprising a box, flexible pouch, envelope, etc.) for receiving and transporting the carrier, a pre-addressed mailing label, and a protective or cushioning material such as protective foam, packing peanuts, and/or shredded paper filler, etc. Significantly, the system of the present application effectively stabilizes raw samples such that the samples do not need to be refrigerated or frozen during shipping or storage.

In a preferred embodiment, the kit is a saliva specific viral collection product. In an aspect, the saliva viral collection kit collection transport products which incorporate a non-dilutive dried media formulation at the bottom of the collection tube. Oral fluid (saliva) is added by simply expectorating into the tube. The media dissolves upon contact with the saliva, thereby stabilizing and protecting the virus and viral RNA.

In a further preferred embodiment, the saliva collection kit uses a dry media formation that eliminates sample dilution. For such a kit, the Limit of Detection (LoD) is actually improved due to a more concentrated sample added to standard RNA preparation.

### Methods of Preparation, Storing, and Preserving

In an embodiment, the compositions are prepared by combining a first solution and a second solution, wherein the first solution comprises a pH buffer/adjuster, at least two hydroxyl/oxygen radical scavengers, a metal chelator, a reducing agent, an inhibitor, a stabilizer, and a solvent (such as water); and wherein the second solution comprises an antimicrobial agent and a third hydroxyl/oxygen radical scavenger.

In an embodiment, a raw sample may be stabilized and stored at room temperature for up to 2 years by providing the composition of the present application, collecting one or more raw samples, mixing the one or more raw samples with the composition of the present application, and optionally allowing the mixture to dry. In some embodiments, the mixture will form a matrix. The mixture may be wholly solid, or solid in part.

In a further embodiment, after stabilization and storage for a desired period of time, the raw sample bound in/by the composition of the present application may be rehydrated by the addition of an aqueous solution (e.g., water or an aqueous buffer) shortly before the composition is to be used in a biochemical reaction (e.g., PCR) or an analysis (e.g., an immunoassay).

In an embodiment, the compositions of the present application as provided in a kit may be used by providing the composition of the present application in a carrier, collecting one or more raw samples, mixing the one or more raw samples with the composition in a carrier, sealing the mixture in the carrier with closures, placing the sealed mixture in an additional container, adding protective materials to the additional container, and applying a pre-addressed mailing label to the additional container.

In a still further embodiment, the composition of the present application may be used as part of automated and/or high throughput preparation, stabilization, and storage of raw samples.

### PREFERRED EMBODIMENTS

Exemplary features of the preferred embodiments are provided in the following numbered paragraphs. Other features disclosed herein may be incorporated within these.

Paragraph 1. A biological transport media comprising:
a pH adjuster;
one or more hydroxyl radical scavengers;
a metal chelator;
a reducing agent;
an inhibitor;
a stabilizer;
an antimicrobial agent; wherein the biological transport media is borate-free.

Paragraph 2. The biological transport media of paragraph 1, wherein the pH adjuster is lithium hydroxide, lithium dodecyl sulfate, lithium chloride, benzylidene rhodanine, sulfosalicylic acid, citric acid, tartaric acid, malic acid, sulfosalicylic acid, sulfoisophthalic acid, oxalic acid, borate, CAPS (3-(cyclohexylamino)-1-propanesulfonic acid), CAPSO (3-(cyclohexylamino)-2-hydroxy-1-propanesulfonic acid), EPPS (4-(2-hydroxyethyl)-1-piperazinepropanesulfonic acid), HEPES (4-(2-hydroxyethyl)piperazine-1-ethanesulfonic acid), MES (2-(N-morpholino)ethanesulfonic acid), MOPS (3-(N-morpholino)propanesulfonic acid), MOPSO (3-morpholino-2-hydroxypropanesulfonic acid), PIPES (1,4-piperazinediethanesulfonic acid), TAPS (N[tris(hydroxymethyl)methyl]-3-aminopropanesulfonic acid), TAPSO (2-hydroxy-3-[tris(hydroxymethyl)methylamino]-1-propanesulfonic acid), TES (N-[tris(hydroxymethyl)methyl]-2-aminoethanesulfonic acid), bicine (N,N-bis(2-hydroxyethyl)glycine), tricine (N-[tris(hydroxymethyl)methyl]glycine), tris (tris(hydroxymethyl)aminomethane), bis-tris (2-[bis(2-hydroxyethyl)amino]-2-(hydroxymethyl)-1,3-propanediol), 5-(4-dimethyl)amino benzylidene rhodanine, or a combination thereof.

Paragraph 3. The biological transport media of any one of paragraphs 1-2, wherein the hydroxyl radical scavenger is mannitol, erythritol, sorbitol, xylitol, azide, cysteine, lithium dodecyl sulfate, dimethylsulfoxide, histidine, salicylic acid, salicylate, monosaccharides, disaccharides, or a combination thereof.

Paragraph 4. The biological transport media of any one of paragraphs 1-3, wherein the inhibitor is aurintricarboxylic acid, boric acid, citric acid, salicylic acid, 1,2-bis(o-aminophenoxy)ethane-N,N,N′,N′-tetraacetic acid (BAPTA), diethylene triamine pentaacetic acid (DTPA), ethylenediaminetetraacetic acid (EDTA), ethylene glycol tetraacetic acid (EGTA), glycoletherdiaminetetraacetic acid (GEDTA), N-(2-hydroxyethyl)ethylenediamine-N,N′,N′-triacetic acid (HEDTA), nitrilotriacetic acid (NTA), 2,2′-bipyridine, o-phenanthroline, triethanolamine, or a combination thereof.

Paragraph 5. The biological transport media of any one of paragraphs 1-4, wherein the metal chelator is boric acid, aurintricarboxylic acid (ATA), borate, citric acid, citrate, salicylic acid, salicylate, 1,2-bis(o-aminophenoxy)ethane-N,N,N′,N′-tetraacetic acid (BAPTA), diethylene triamine pentaacetic acid (DTPA), ethylenediaminetetraacetic acid (EDTA), ethylene glycol tetraacetic acid (EGTA), glycoletherdiaminetetraacetic acid (GEDTA), N-(2-hydroxyethyl)ethylenediamine-N,N′,N′-triacetic acid (HEDTA), nitrilotriacetic acid (NTA), 2,2′-bipyridine, o-phenanthroline, triethanolamine, or a combination thereof.

Paragraph 6. The biological transport media of any one of paragraphs 1-5, wherein the reducing agent is EDTA, EGTA, o-phenanthroline, dithionite, dithioerythritol, dithiothreitol (DTT), dysteine, 2-mercaptoethanol, mercaptoethylene, bisulfite, sodium metabisulfite, pyrosulfite, pentaerythritol, thioglycolic acid, citrate, urea, uric acid, vitamin C, vitamin E, superoxide dismutases, or a combination thereof.

Paragraph 7. The biological transport media of any one of paragraphs 1-6, wherein the stabilizer is polyethylene glycol.

Paragraph 8. The biological transport media of any one of paragraphs 1-7, wherein the antimicrobial agent is penicillin, cephalosporin, ampicillin, amoxycillin, aztreonam, clavulanic acid, imipenem, streptomycin, gentamycin, vancomycin, clindamycin, polymyxin, erythromycin, bacitracin, amphotericin, nystatin, rifampicin, tetracycline, chlortetracycline, doxycycline, chloramphenicol, ammolfine, butenafine, naftifine, terbinafine, ketoconazole, fluconazole, elubiol, econazole, econaxole, itraconazole, isoconazole, imidazole, miconazole, sulconazole, clotrimazole, enilconazole, oxiconazole, tioconazole, terconazole, butoconazole, thiabendazole, voriconazole, saperconazole, sertaconazole, fenticonazole, posaconazole, bifonazole, flutrimazole, nystatin, pimaricin, amphotericin B, flucytosine, natamycin, tolnaftate, mafenide, dapsone, caspofungin, actofunicone, griseofulvin, potassium iodide, Gentian Violet, ciclopirox, ciclopirox olamine, haloprogin, silver sulfadiazine, undecylenate, undecylenic acid, undecylenic alkanolamide, Carbol-Fuchsin, nevirapine, delavirdine, efavirenz, saquinavir, ritonavir, indinavir, nelfinavir, amprenavir, zidovudine (AZT), stavudine (d4T), lamivudine (3TC), didanosine (DDI), zalcitabine (ddC), abacavir, acyclovir, penciclovir, valacyclovir, ganciclovir, rutin, tannic acid, Direct Red 80, or a combination thereof.

Paragraph 9. The biological transport media of any one of paragraphs 1-8, wherein the media is a solid or a liquid.

Paragraph 10. The biological transport media of any one of paragraphs 1-9, wherein the media comprises about 1-10% of the pH adjuster, about 15-35% of the one or more hydroxyl radical scavengers, about 5-25% of the metal chelator, about 15-30% of the reducing agent, about 0.1-5% of the inhibitor, about 35-55% of the stabilizer, and about 0.5-10% of the antimicrobial agent.

Paragraph 11. The biological transport media of any one of paragraphs 1-10, further comprising a serine protease.

Paragraph 12. The biological transport media of paragraph 11, wherein the serine protease is Proteinase k.

Paragraph 13. A method of storing a biological sample comprising: adding the biological sample to the biological transport media of any one of paragraphs 1-12.

Paragraph 14. The method of paragraph 13, wherein the biological sample is whole blood, plasma, nasopharyngeal secretion, saliva, fecal matter, or sputum.

Paragraph 15. The method of paragraph 13 or 14, wherein the biological sample is when a liquid added to the biological transport media and is dried on the biological transport media.

Paragraph 16. A method of manufacturing the biological transport media of any one of paragraphs 1-12, the method comprising:
preparing a first solution comprising a pH buffer, a first hydroxyl radical scavenger, a second hydroxyl radical scavenger, a metal chelator, a reducing agent, an inhibitor, and a stabilizer;
preparing a second solution comprising an antimicrobial agent and a third hydroxyl radical scavenger;
combining the first solution and the second solution.

Paragraph 17. A biological sample collection kit comprising:
a sample carrier; and
a transport media comprising a hydroxyl radical scavenger and/or an oxygen radical scavenger; a metal chelator; and a serine protease; wherein the transport media is borate-free.

Paragraph 18. The biological sample collection kit of paragraph 17, wherein the hydroxyl radical scavenger and/or oxygen radical scavenger is mannitol, erythritol, sorbitol, xylitol, azide, cysteine, lithium dodecyl sulfate, dimethylsulfoxide, histidine, salicylic acid, salicylate, monosaccharides, disaccharides, or a combination thereof.

Paragraph 19. The biological sample collection kit of paragraph 17 or 18, wherein the metal chelator is boric acid, aurintricarboxylic acid (ATA), borate, citric acid, citrate, salicylic acid, salicylate, 1,2-bis(o-aminophenoxy)ethane-N,N,N′,N′-tetraacetic acid (BAPTA), diethylene triamine pentaacetic acid (DTPA), ethylenediaminetetraacetic acid (EDTA), ethylene glycol tetraacetic acid (EGTA), glycoletherdiaminetetraacetic acid (GEDTA), N-(2-hydroxyethyl)ethylenediamine-N,N′,N′-triacetic acid (HEDTA), nitrilotriacetic acid (NTA), 2,2′-bipyridine, o-phenanthroline, triethanolamine, or a combination thereof; and wherein the serine protease is Proteinase k.

Paragraph 20. The biological sample collection kit of any one of paragraphs 17-19, wherein the sample carrier is a saliva collection tube, a vial, a collection cup, a corrugated jar, a container jar, a collection tube, an absorbent pouch, and/or a collection tube comprising a swab.

The preceding paragraphs are intended to be non-limiting illustrations of most preferred embodiments of the technology disclosed herein.

### EXAMPLES

Preferred embodiments are further defined in the following non-limiting Examples. It should be understood that these Examples, while indicating certain embodiments, are given by way of illustration only. From the above discussion and these Examples, it is possible to ascertain key aspects of the disclosure such that, without departing from the spirit and scope thereof, it is possible to make various changes and modifications to the embodiments to adapt it to preferred conditions and usages. Thus, various modifications of the embodiments, in addition to those shown and described herein, will be apparent from the foregoing description. Such modifications are also intended to fall within the scope of the appended claims.

### Example 1

Liquid stabilization media was prepared and assessed for the extent of viral RNA recovery at 30 days. The total amount of viral RNA recovered in an assay bears a direct relationship on analytical sensitivity and specificity. Contrived nasopharyngeal (NP) samples were prepared by first diluting the SARS CoV-2 viral RNA to 20.6 geq/μL. The SARS CoV-2 viral RNA was combined with 1 mL of the composition according to Table 3A below, and separately with 3 mL of UNITRANZ UTM (from Puritan), which was used as a comparison.

TABLE 3A
GTR-VTM Formulation.

| Component | Per mL | Units | Final Mg | Units | % total |
|---|---|---|---|---|---|
| LiOH | 43.06 | mg | 35.883 | mg | 4% |
| D-Mannitol | 19.26 | mg | 16.050 | mg | 2% |
| LiDS | 90 | mg | 75.000 | mg | 8% |
| EGTA | 193.8 | mg | 161.500 | mg | 16% |
| Urea | 288 | mg | 240.000 | mg | 24% |
| ATA | 12.67 | mg | 10.558 | mg | 1% |
| Water | 500 | uL | 416.667 | uL | 42% |
| Peg | 500 | uL | 416.667 | uL | 42% |
| Make Rutin with | | | | | |
| DMSO separately | | | | | |
| Rutin | 22 | mg | 18.333 | mg | 2% |
| DMSO | 200 | uL | 166.667 | uL | 17% |
| Final vol. | | | 1000.000 | uL | 156% |

TABLE 3B
Nasopharyngeal and OP Flocks Composition

| Reagents | Amount | Units |
|---|---|---|
| ATA | 4.8 | mg/mL |
| PBS Solution | Up to the remainder | |

Control samples were placed in storage at −80° C. The experimental samples were stressed at 25° C., 37° C., 46° C., and 56° C. The temperatures at which the samples were stored are equivalent to a number of days:

Equivalent Days at Ambient with Accelerated Aging

| | | | | | |
|---|---|---|---|---|---|
| 37° C. | 2 | 5 | 11 | 23 | Equivalent |
| 46° C. | 4 | 9 | 21 | 43 | Days @ |
| 56° C. | 9 | 17 | 43 | 86 | Ambient |
| | 1 | 2 | 5 | 10 | Days @ |
| | | | | | Accelerated |
| | | | | | Temperature |

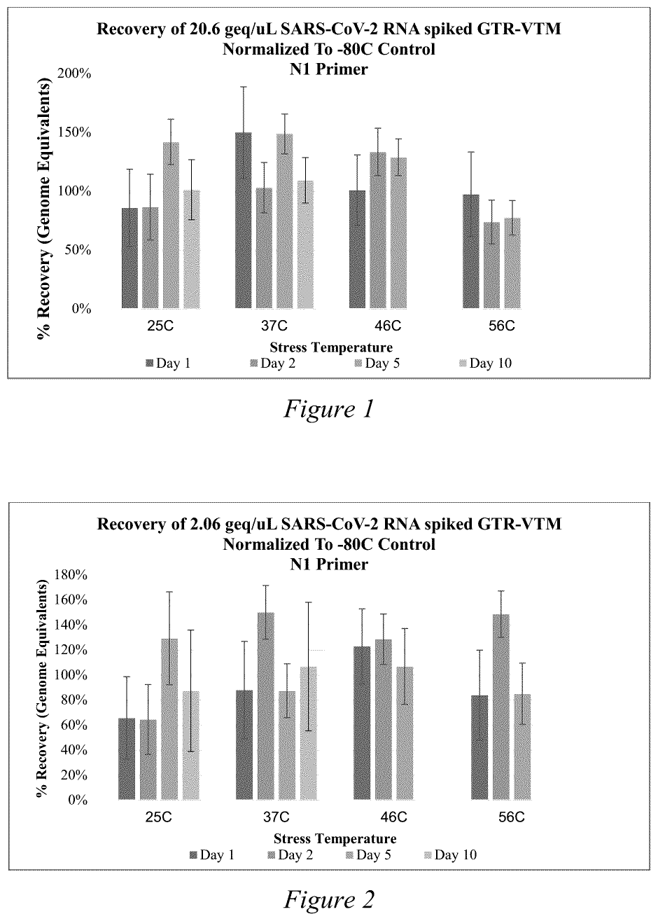

This stress study of the samples was used to determine the stability of the SARS-CoV-2 RNA in UTM and the GTR-VTM media of Table 3A. This analysis was performed by incubating the UTM and the GTR-VTM with viral RNA at elevated temperatures of 25° C. to 56° C. for up to 10 days. SARS-COV-2 viral RNA at 20.6 genome equivalents/uL (geq/uL) spiked on floc was added to 1 mL of GTR-VTM media and to UTM media. Both the contrived VTM and UTM were placed at 25° C., and 37C for 1, 2, 5 and 10 days and at 46C and 56C for 1, 2 and 5 days. Matched controls were placed at −80° C. Viral RNA from 100 uL of the VTM/UTM sample was extracted with the QIAamp viral RNA kit and eluted with 100 uL of elution buffer. 5 uL of the viral RNA was added to 15 uL of rt-qPCR mastermix made with TaqPath reagent (Life Technologies) and CDC's N1 primers. No SARS-CoV-2 viral RNA was recovered from the UTM media and so was abandoned after day 1 of the stress study. GTR-VTM gave 100% recovery of the viral RNA at 25° C., 37° C. for 10 days and at 46° C. for 5 days and more than 50% RNA was recovered from the 56 days for day 5. The results of this analysis are shown in FIG. 1.

Next, SARS-COV-2 viral RNA at 2.06 genome equivalents/uL (geq/uL) was spiked on floc was added to 1 mL of GTR-VTM media and to UTM media. Both the contrived VTM and UTM were placed at 25° C., and 37° C. for 1, 2, 5 and 10 days and at 46° C. and 56° C. for 1, 2 and 5 days. Matched controls were placed at −80° C. Viral RNA from 100 uL of the VTM/UTM sample was extracted with the QIAamp viral RNA kit and eluted with 100 uL of elution buffer. 5 uL of the viral RNA was added to 15 uL of rt-qPCR mastermix made with TaqPath reagent (Life Technologies) and CDC's N1 primers. No SARS-CoV-2 viral RNA was recovered from the UTM media and so was abandoned after day 1 of the stress study. GTR-VTM gave more than 50% recovery of the viral RNA at 25C, 37C, 46C and 56C for the entire duration of the stress study. The results of this test are shown in FIG. 2. Overall, the GTR-VTM formulation of Table 3A provided greater than 50% stability of SARS-CoV-2 viral RNA extracted therefrom, and substantially better recovery than the comparative media, even at very low initial concentrations of viral RNA, implying good analytical specificity.

### Example 2

Liquid stabilization media was prepared and assessed for the extent of virus recovery at 30 days. In particular, contrived nasopharyngeal (NP) samples were prepared by diluting heat inactivated SARS-CoV-2 virus samples to 20.6 geq/4. The SARS CoV-2 virus was combined with 1 mL of the composition according to Table 3A (as used in Example 1), and separately with 3 mL of UNITRANZ UTM (from Puritan), which was used as a comparison.

Control samples were placed in storage at −80° C. The experimental samples were stressed at 25° C., 37° C., 46° C., and 56° C., as outlined in Example 1. The samples were then extracted at days 1, 2, 5 and 10 for the 25° C. and 37° C. stressed samples and at days 1, 2 and 5 for 46° C. and 56° C. samples. Viral RNA was extracted from 140 μL of the composition of Table 3A and the UTM samples with QIAamp viral RNA kit for each time point and eluted in 140 μL of elution buffer as per CDC recommended SARS-CoV-2 analysis protocol for NP samples. The extracted viral RNA was quantified with EUA certified TaqPath RT-qPCR assay.

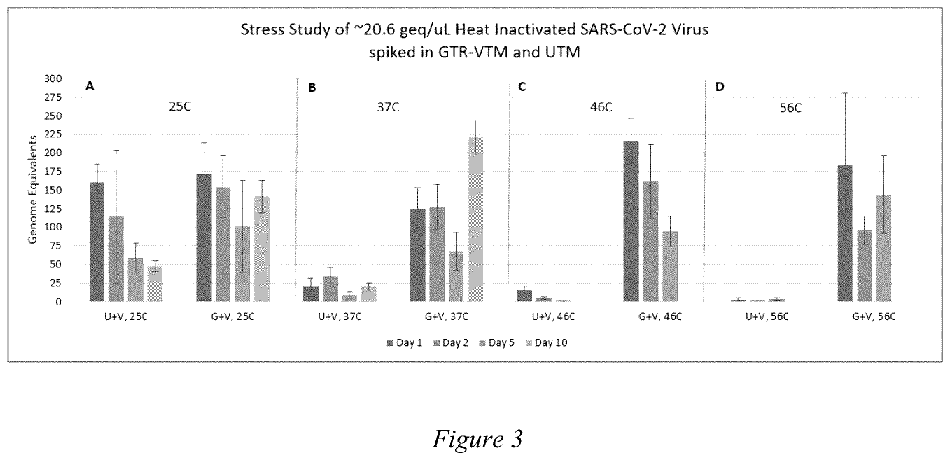

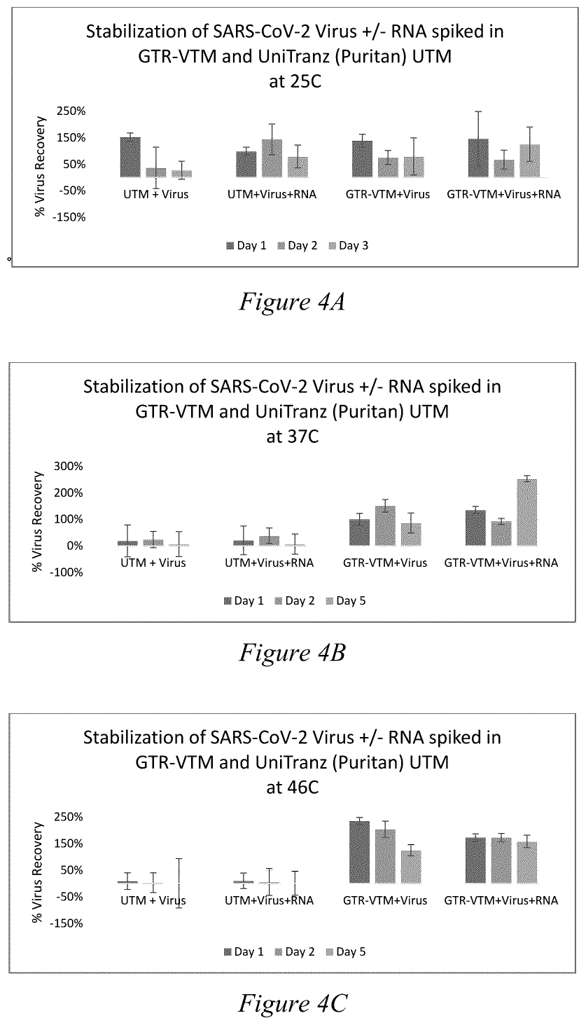

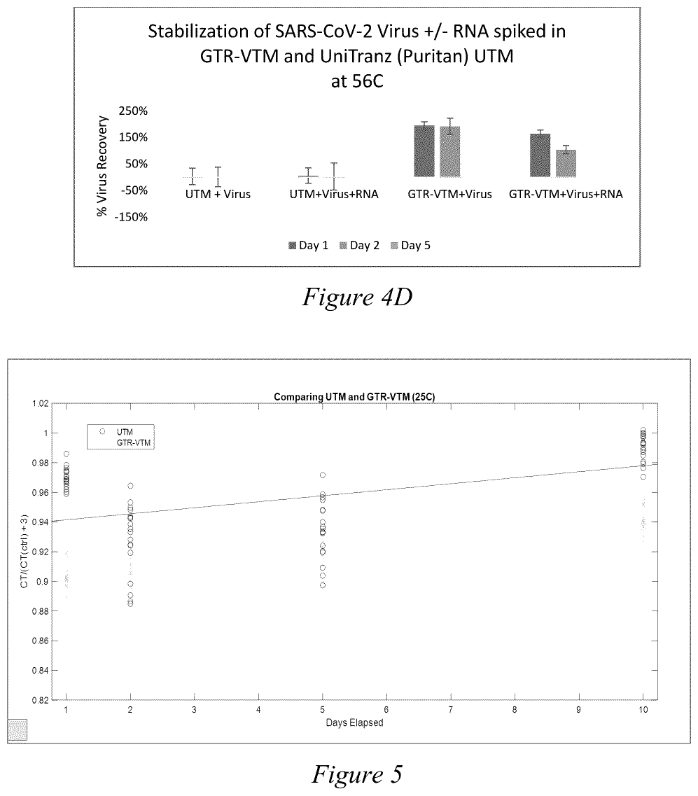

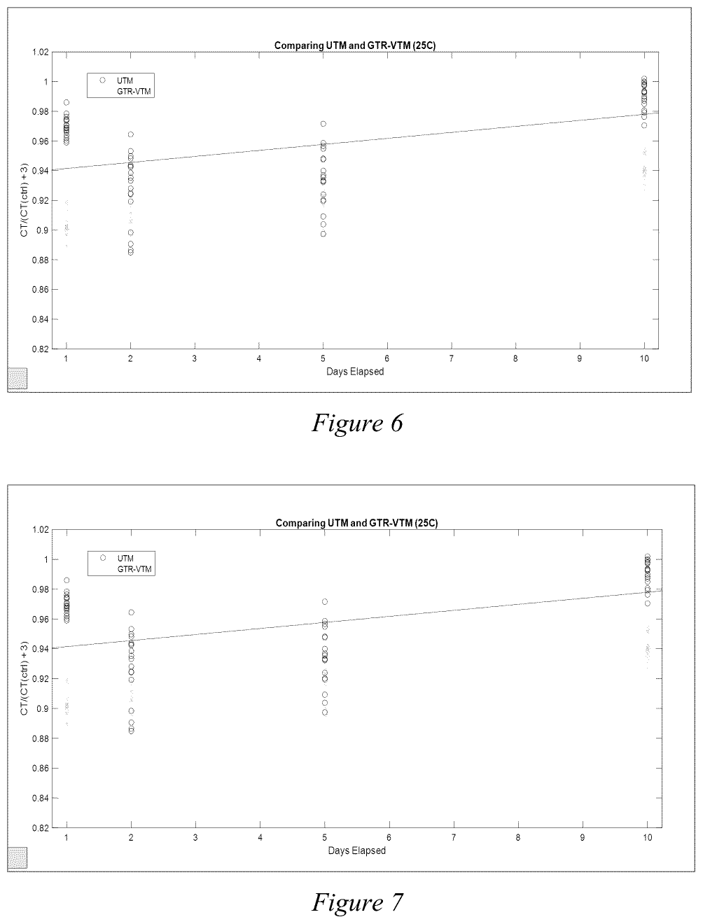

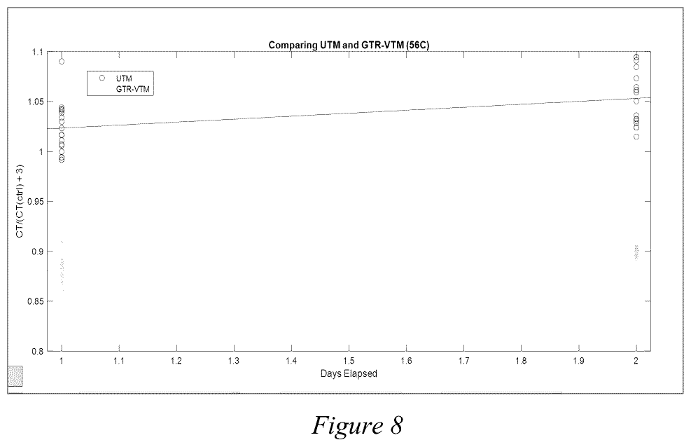

The number of genome equivalents detected is shown in FIGS. 3-8. As depicted in FIGS. 3 and 4A-4D, after day 2, the recovery of the UTM media was reduced substantially. Further, as temperature increased, the recovery of the UTM became essentially negligible. In comparison, the VTM media of Table 3A consistent provided greater than 50 genome equivalents, and in most cases more than 100 genome equivalents recovered.

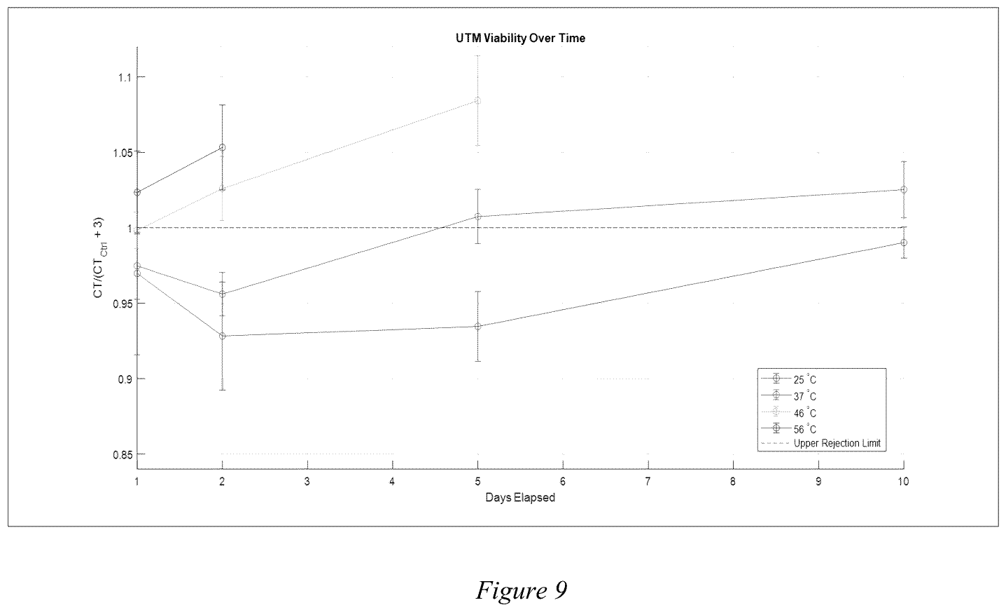

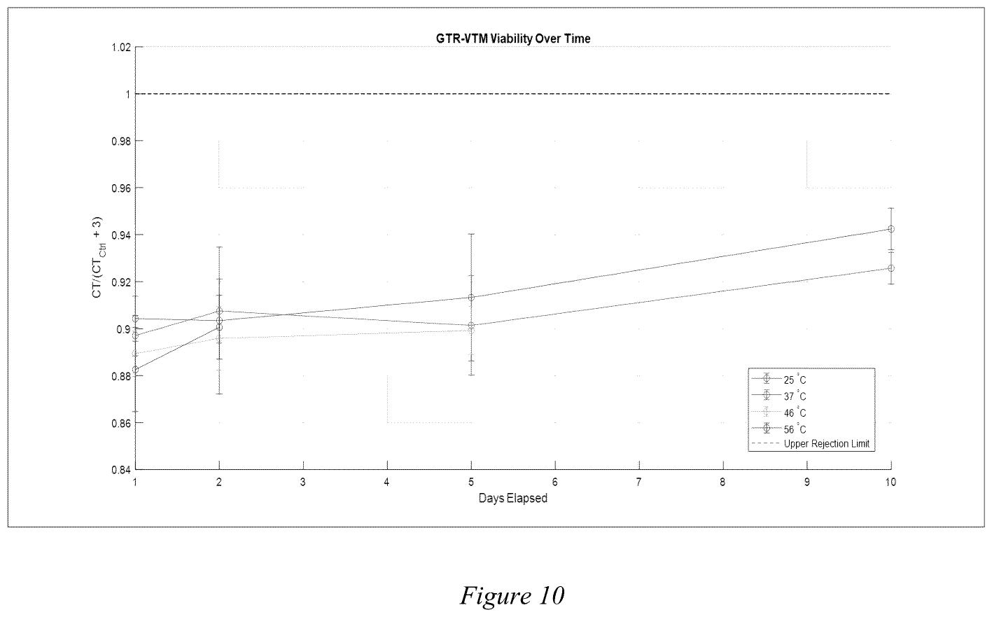

Next, following quantification of viral RNA, a 3-way ANOVA was conducted for the various stress samples to identify statistical significance in the data points between every independent variable and their interactions with each other. The relevant variables utilized in the ANOVA are shown in Table 4. The results are of the ANOVA are also depicted in FIGS. 9-10.

TABLE 4
Analysis of Variance

| | Sum | | Mean | | Prob > |
|---|---|---|---|---|---|
| Source | Sq. | d.f. | Sq. | F | F |
| Medium | 0.12751 | 1 | 0.12751 | 333.36 | 0 |
| Time | 0.03316 | 1 | 0.03316 | 86.69 | 0 |
| Temp | 0.00712 | 3 | 0.00237 | 6.2 | 0.0004 |
| Medium*Time | 0.00497 | 1 | 0.00497 | 12.99 | 0.0003 |
| Medium*Temp | 0.02019 | 3 | 0.00673 | 17.6 | 0 |
| Medium*Time*Temp | 0.02558 | 3 | 0.00853 | 22.3 | 0 |
| Error | 0.17288 | 452 | 0.00038 | | |
| Total | 1.63716 | 467 | | | |

The CT values of both the composition of Table 3A and UTM were normalized against corresponding −80° C. controls. Nasopharyngeal transport media samples with CT changes greater than 3 CT are not considered to meet the criteria of stabilization for SARS-CoV-2 virus. A rejection threshold of (CTCtrl+3) was therefore weighed against each sample based on the CT values of the matched −80° C. control sample values. Those stress samples where the ratio CT/(CTCtrl+3)>1 surpassed the rejection threshold were considered no longer viable because they have degraded beyond usability.

As shown in FIG. 1, for the UTM medium, only the 25° C. sample was below the rejection threshold (rejection threshold=1) for the entire duration of the analysis. The 46° C. sample was just below the threshold for day 1 samples and the 56° C. sample was above the threshold always. The 37° C. sample passed the rejection threshold by day 5. The sample remained stable for 10 days but was very close to the rejection threshold at day 10. These data indicate that the UTM medium provides stability only under a relatively narrow set of temperature and time conditions.

In comparison, as shown in FIG. 2, all of the trial samples for the exemplary composition of Table 3A remained below the rejection threshold (rejection threshold=1) for the entire duration of the analysis, indicating all samples remain viable throughout the ageing process. As the liquid transport media of Table 3A is particularly suitable for nasopharyngeal secretions and fecal samples, FIG. 2 further indicates that biological samples from nasopharyngeal swabs and stool cultures can be effectively stabilized and stored.

### Example 3

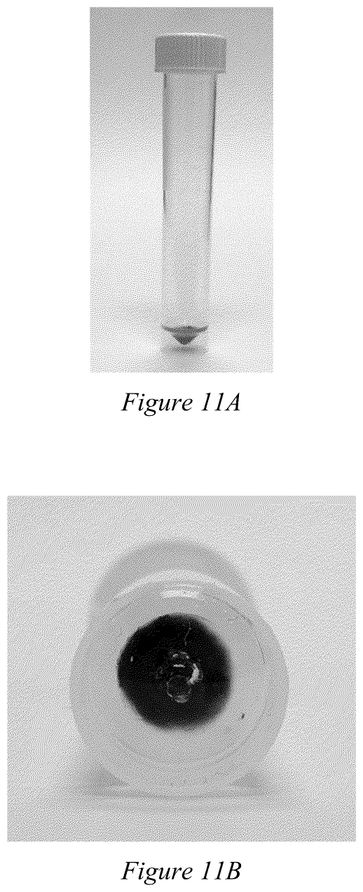

Solid stabilization media was prepared and assessed for the extent of viral RNA recovery at 30 days. 1 mL of saliva sample containing 20.6 geq/μL of SARS CoV-2 viral RNA was added to a dry transport media according to Table 5 below. In particular, each saliva collection tube containing the STM formulation of Table 5 contained approximated 30 mg of dry product suspended in 55 μL of liquid. The liquid was then dried for 2 hours at 56° C., rendering the media and sample a solid. A saliva collection tube, with the exemplary composition of Table 5, is shown in FIGS. 11A-11B.

TABLE 5
STM Formulation

| | Amount in | | | Amount in | Amount |
|---|---|---|---|---|---|
| Reagent | 4 mL | Units | % | 30 mg | converted to g |
| LiOH | 287.07 | Mg | 12 | 3.60 | 0.0036 |
| D-Mannitol | 128.4 | Mg | 5 | 1.61 | 0.0016 |
| LiDS | 600 | mg | 25 | 7.53 | 0.0075 |
| EGTA | 1292 | mg | 54 | 16.20 | 0.0162 |
| ATA | 84.47 | mg | 4 | 1.06 | 0.0011 |
| Total | 2391.94 | mg | 1 | 30 | 0.03 |

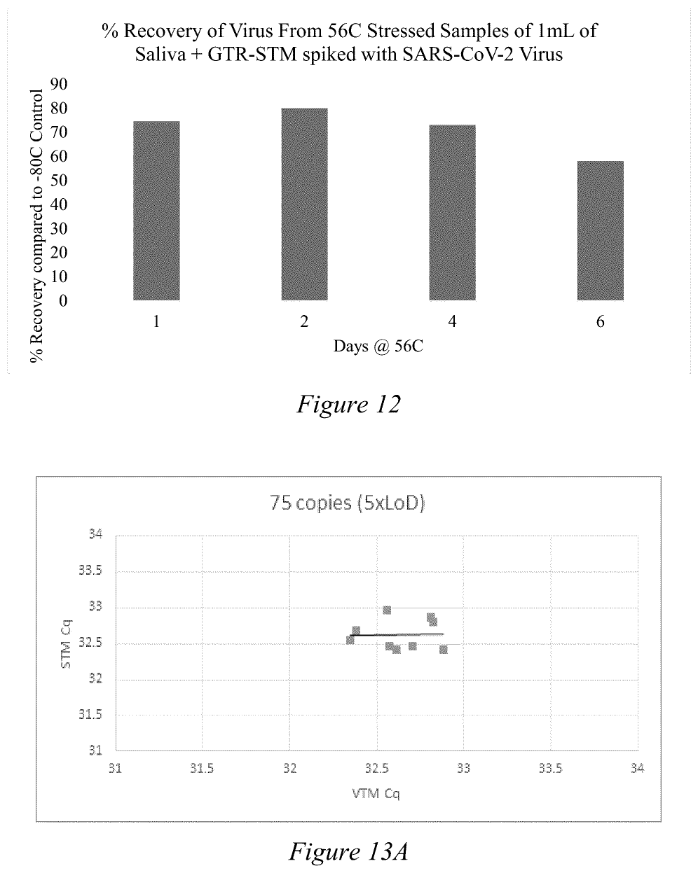

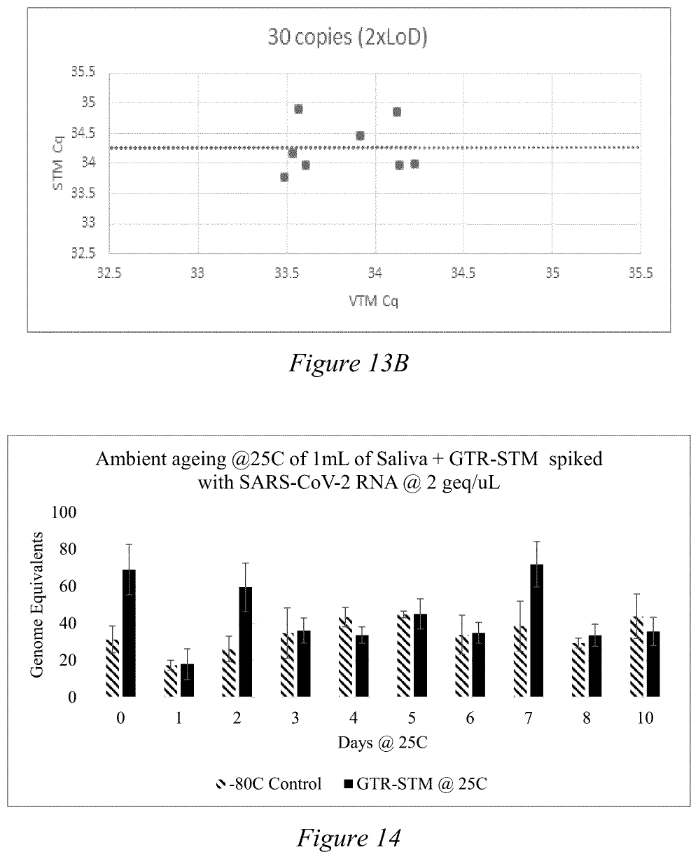

As a control, 1 mL of RNASecure water was spiked with 2.0 geq/μL viral RNA and stored at −80° C. The saliva samples collected and stored in the media of Table 5 were also compared to nasopharyngeal samples stored according to Example 1. All salivary and nasopharyngeal samples were contrived to have matching viral SARS-CoV-2 loads per uL reagent. Total RNA was then quantified from the salivary samples stabilized with the formulation of Table 5 and the nasopharyngeal samples stabilized with the formulation of Table 3. The control Norgen Biotek samples were also assessed and quantified based on the reduced quantity of SARS-CoV-2 virus. One milliliter of saliva contrived with 2 copies/uL of gamma irradiated SARS-CoV-2 virus was added to GTR-STM. The contrived GTR-STM was stressed at 56° C. for days 1, 2, 4 and 6. Matched control samples of GTR-STM were placed at −80° C. Viral RNA was extracted from 100 uL of saliva sample with QIAamp viral RNA kit and quantified with TaqPath rt-qPCR mix and CDC's N1 primers. Greater than 50% of viral RNA was recovered from GTR-VTM stressed at 56° C. for 6 days. Further, as shown in FIGS. 13A-13B, non-dilutive contrived saliva samples according to Table 5 provide comparable Cq (CT) values comparable to the nasopharyngeal samples stabilized with the composition of Table 3. The results of this analysis are shown in FIG. 12. FIG. 12 shows that the GTR-STM media provides excellent recovery, even after storage for 6 days at 56° C. Beneficially, the solid transport media suitable for stabilizing saliva samples provide superior, long-term stabilization of viral samples—specifically SARS CoV-2 samples.

### Example 4

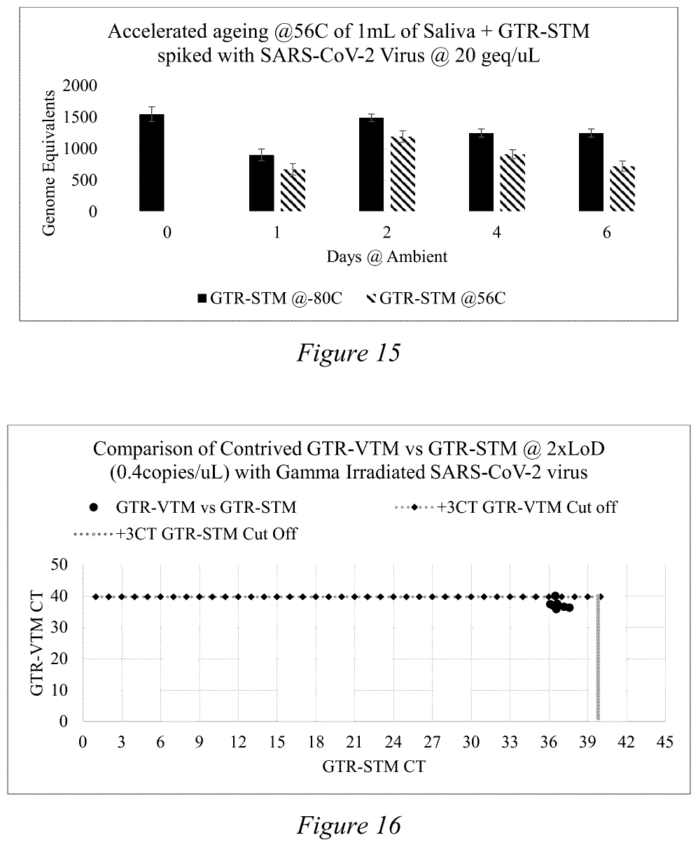

In addition to the stabilization of viral RNA, whole virus spiked saliva was stabilized in the STM media according to Table 5 and assessed using the methods of Example 3. In addition to a −80° C. control, the viral RNA saliva samples were compared to RNA extracted with the MagMax Viral RNA Kit from both untreated saliva and saliva treated with the STM media. As shown in FIG. 14, saliva containing viral RNA extracted from the virus in the STM media provide greater than 50% recovery as compared to the −80° C. control. Further, as shown in FIG. 15, even under high temperature conditions, simulating more than 40 days of storage, the STM media of Table 5 provides greater than 50% recovery compared to the −80° C. control.

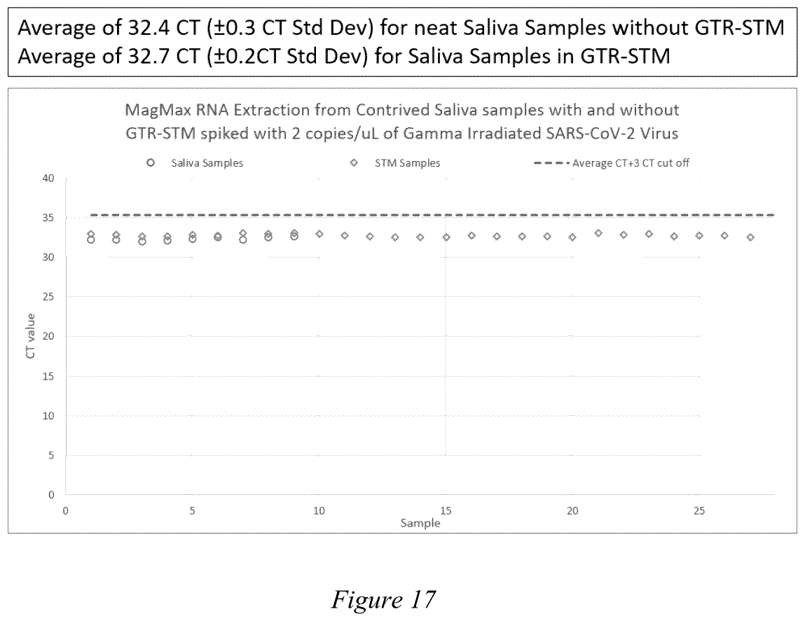

Next, contrived neat (untreated) saliva samples without the STM media were prepare by spiking 2 copies of Y-irradiated SARS-CoV-2 virus per μL. The contrived saliva samples treated with the STM media of Table 5 were prepared by spiking 1 mL of saliva with two copies of Y-irradiates SARS-CoV-2 virus. RNA was extracted from both samples following the manufacturer's instructions for the MagMax Viral RNA manual protocol. Finally, 5 uL of extracted RNA were amplified for each sample with TaqPath master mix and CDC's N1 Primer. The results of this analysis are shown in FIG. 17. As shown in FIG. 17, the saliva samples treated with the STM media of Table 5 demonstrate a recovery rate very close to the saliva sample control as indicated by a CT value that is substantially the same as the neat saliva control.

### Example 5

The biological transport media described herein were assessed for their ability to recover gamma irradiated SARS-CoV-2 virus. Nasopharyngeal samples were combined with 1 mL of the VTM media of Table 3A and spiked with gamma irradiated SARS-CoV-2 virus to yield 0.4 copies per μL of virus. Additionally, saliva samples were combined with 1 mL of the STM media of Table 5 and spiked with gamma irradiated SARS-CoV-2 virus to yield 0.4 copies per μL of virus. Next, RNA was extracted using the QIAamp viral RNA kit from each of the samples. Finally, 5 μL of RNA was quantified with TaqPath mastermix and CDC's N1 primer.

The results of this analysis are shown in FIG. 16. This Figure shows that the samples stabilized in the VTM media and the STM media provide excellent recovery of viral RNA as indicated by CT values that fall below both the GTR-VTM and GTR-STM rejection thresholds.

Next, the Cq/CT values for the GTR-VTM formula assessed in Examples 1-2 and the GTR-STM formula of Example 3 were compared. The results are depicted in FIGS. 13A-13B. As shown in these Figures, both GTR-STM and GTR-VTM samples containing matched viral loads provided comparable and positive reactions, effectively indicating the presence of the SARS-CoV-2 viral RNA even at 2× LoD and 5× LoD. LoD is an important parameter for analytical sensitivity, thus the results shown in FIGS. 13A-13B indicate the GTR-STM and GTR-VTM media provide high sensitivity.

### Example 6

In addition to the VTM and STM media described in Examples 1-5, further storage media were prepared for direct-to-PCR (“direct”) stabilization. A solid direct-to-PCR formulation was prepared according to Table 6 below.

TABLE 6
STMD Formulation

| | | | | Amount of | |
|---|---|---|---|---|---|
| Reagents | Amount | Units | % | Reagent | Units |
| Water | 1 | mL | 98.8024 | 1000 | mL |
| ATA | 0.002 | g | 0.197605 | 25 | g |
| LiDS | 0.010121 | g | 1 | 25 | g |
| Total | 1.012121 | g | 100 | | |

Following preparation of the media, contrived samples were prepared by spiking gamma irradiated SARS-CoV-2 virus in 1 mL of a saliva sample. Contrived saliva sample in GTR-STMD spiked with gamma irradiated SARS-CoV-2 virus at 2×LoD were subjected to 5 different treatments. Saliva samples were processed by spinning the saliva sample at 20k rcf in a centrifuge, sonicating the sample with glass beads for 1 minute and again spinning in the centrifuge at 20k rcf. Next, the sample was bead beat with Zirconia beads and spun again in the centrifuge at 20k rcf. Finally, the sample was heated for five minutes at 65° C. with agitation at 850 rpm, before being spun at 20k rcf. Next, the samples were quantified by adding 5 μL of each of the samples to 15 μL of TAqPath mastermix and quantified for nucleocapsid (N1) or RNAse-P. RNAse-P is a “housekeeping” gene used as an internal control for the sample.

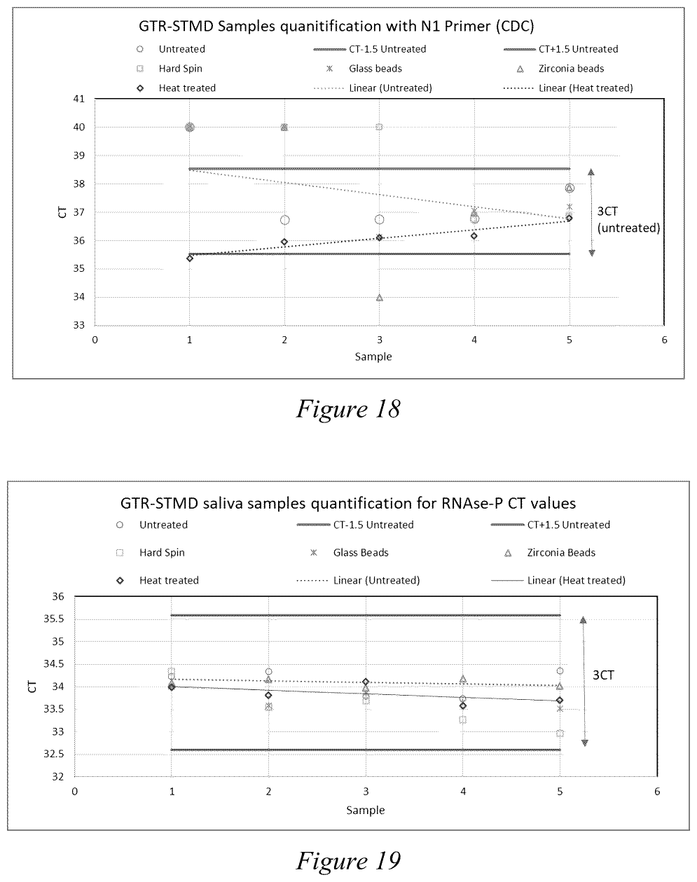

The results of this analysis are shown in FIGS. 17-18. FIG. 18 shows samples quantified with N1 Primer. In FIG. 18, the 3 CT range in the graph is created by the untreated control samples. Undetermined samples were given a CT of 40 cycles. Samples above CT 38.5 were considered failed samples. All heat-treated samples passed with CT values between 35 and 37.

FIG. 19 and Table 7 show samples quantified for RNAse-P. In FIG. 19, the 3CT range is to untreated control samples, while undetermined samples were given a CT of 40 cycles. Samples above CT 35.5 were considered failed samples. All heat-treated samples passed with CT values between 32.5 and 35.5.

TABLE 7

| | | N1 | | N2 | | Rnase P | | | N1 | | N2 | | Rnase P | |
|---|---|---|---|---|---|---|---|---|---|---|---|---|---|---|
| | | | Std | | Std | | Std | | | Std | | Std | | Std |
| | | CT | Dev | CT | Dev | CT | Dev | | CT | Dev | CT | Dev | CT | Dev |
| | | 0.4 Copies/uL of SARS-CoV-2 + | | | | | | | 2 Copies/uL of SARS-CoV-2 + | | | | | |
| | | Saliva in GTR-STM | | | | | | | Saliva in GTR-STM | | | | | |
| GTR-STM | 4 C. | 37.52 | 1.72 | 37.88 | 0.62 | 35.24 | 0.36 | 4 C. | 34.33 | 0.38 | 35.46 | 0.44 | 34.88 | 0.37 |
| (Saliva) | 65 C. | 36.85 | 0.89 | 38.66 | 1.10 | 35.09 | 0.72 | 65 C. | 34.74 | 0.22 | 35.73 | 0.48 | 34.87 | 0.33 |
| | 70 C. | 37.54 | 1.23 | 39.01 | 1.25 | 35.09 | 0.52 | 70 C. | 34.66 | 0.22 | 36.51 | 0.38 | 35.55 | 0.57 |
| | | 0.4 Copies/uL of SARS-CoV-2 + | | | | | | | 2 Copies/uL of SARS-CoV-2 + | | | | | |
| | | Saliva only (No STM) | | | | | | | Saliva in GTR-STM | | | | | |
| Neat Saliva | 4 C. | 37.05 | 0.47 | 38.92 | 1.04 | 35.72 | 0.67 | 4 C. | 34.75 | 0.59 | 35.72 | 0.64 | 35.47 | 0.37 |
| Water only | | n/a | | n/a | | n/a | | | n/a | | n/a | | n/a | |
| Control | | | | | | | | | | | | | | |

### Example 7

A further assessment was conducted to assess the impact of adding Proteinase K (commonly referred to as Endopeptidase K or Protease K) into the transport media composition. Proteinase K is a broad-spectrum serine protease which digests proteins primarily by cleaving the peptide bond adjacent to the carboxyl group of aliphatic and aromatic amino acids with blocked alpha amino groups. Proteinase K is frequently used during DNA extraction to digest contaminating proteins and remove the contamination from preparations of nucleic acid. It also degrades nucleases that can be present during DNA extract and further protects the nucleic acids from nuclease attack by rapidly inactivating the nucleases that might otherwise degrade the DNA (or RNA).

As the transport media described herein permit direct-to-PCR analysis, it would be beneficial to include Proteinase K into the transport media to boost biological sample recovery and minimize or eliminate contamination. Proteinase K has a shelf life of approximately 12 months when stored at about 2-8° C. in a dry environment and can be used within a short time frame (about 203 days) at room temperature. However, it was unclear if Proteinase K would retain sufficient stability when incorporated into the transport media described herein, wherein the media may be dried and stored at a wide variety of temperatures for long periods of time (e.g. high temperatures simulating more than 40 days of storage).

20 contrived GTR-STMD samples were prepared by adding 1 mL of saliva containing gamma irradiated SARS-CoV-2 virus at 2×LoD (0.4 copies/uL), 5×LoD, and LoD each. The STMD formula utilized was the formula of Table 6, while the VTMD formula was the same formula as STMD except that where STMD was provided as a dry composition (for 1 mL saliva), the VTMD was provided as a 1 mL liquid composition suspended in a suitable carrier. All treated saliva samples were combined with the STMD media of Table 6 or the VTMD media, and Proteinase K+Heat. The 5 μL of Proteinase K treated saliva samples were added directly in Taqpath Mastermix.

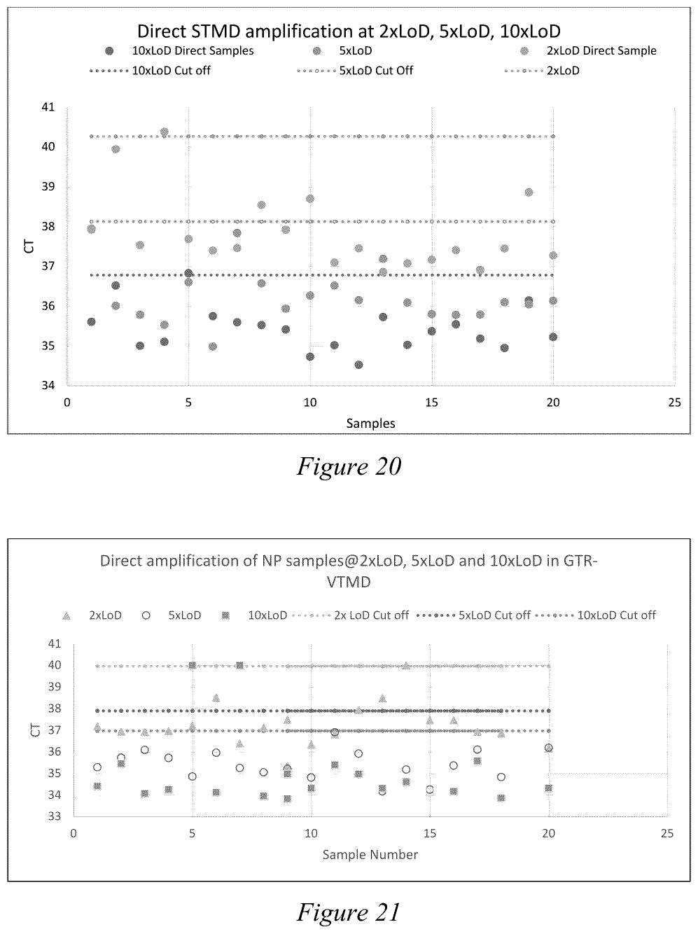

The results of the assessment using the STMD media are shown in FIG. 20. In FIG. 20, the criteria for a “pass” >95% positive for the 2× LoD and 100% for both the and 10× LoD. All Proteinase K treated samples passed the relevant criteria: the samples at 2× LoD provided 95% recovery and the samples at 5× LoD and 10× LoD provided 100% recovery as indicated by CT values below the relevant cutoff value.

The results of the assessment using VTMD media are shown in FIG. 21. The criteria for a “pass” in FIG. 21 was the same as FIG. 20. FIG. 21 shows that the 2× and 5× LoD Proteinase K samples pass (providing 95% and 100% recovery, respectively), while the 10× LoD sample in some instances did not provide 100% recovery.

### Example 8

Direct amplification was conducted on nasopharyngeal/OP samples collected in the VTMD solution of Example 7 with Proteinase K or heat treatment. Contrived VTMD samples were prepared by spiking 1 mL of VTMD media with a nasopharyngeal swab containing 30 μL of nasopharyngeal matrix and gamma irradiated SARS-CoV-2 virus to yield 0.4 copies per μL. The VTMD nasopharyngeal samples were then extracted using the QIAamp viral RNA kit, and 5 μL of the extracted RNA was added into Taqpath mastermix. The samples were then treated by heating at 65° C. or adding Proteinase K. Finally, the heat-treated saliva was added directly to Taqpath Mastermix. CT values were determined for the samples that were extracted, treated with Proteinase K, and treated with heat. This procedure is shown in Table 8 below.

TABLE 8

| | NP | | NP | | NP |
|---|---|---|---|---|---|
| | Sample | | Sample | | Sample |
| CT | Treatment | CT | Treatment | CT | Treatment |
| 36.28 | QIAamp | 37.44905 | Direct | 37.79665 | Direct |
| 35.35 | viral | 36.7309 | into | 36.91244 | into |
| 36.83 | RNA kit | 36.91598 | RT-qPCR | 37.08273 | RT-qPCR |
| 36.07 | Extracted | 36.47499 | after | 37.43632 | after |
| 36.95 | samples | 38.6339 | Proteinase | 39.81678 | Heat |
| 36.19 | | 36.87534 | K treatment | 38.07413 | treatment |
| 38.07 | | 38.57762 | | 36.89584 | |
| 36.6 | | 37.99012 | | 36.80288 | |
| 37.28 | | 36.57594 | | 38.32785 | |
| 36.63 | Average | 37.36 | Average | 37.68 | Average |
| | CT | | CT | | CT |
| 0.784 | Deviation | 0.85 | Standard | 0.97 | Standard |
| | Standard | | Deviation | | Deviation |

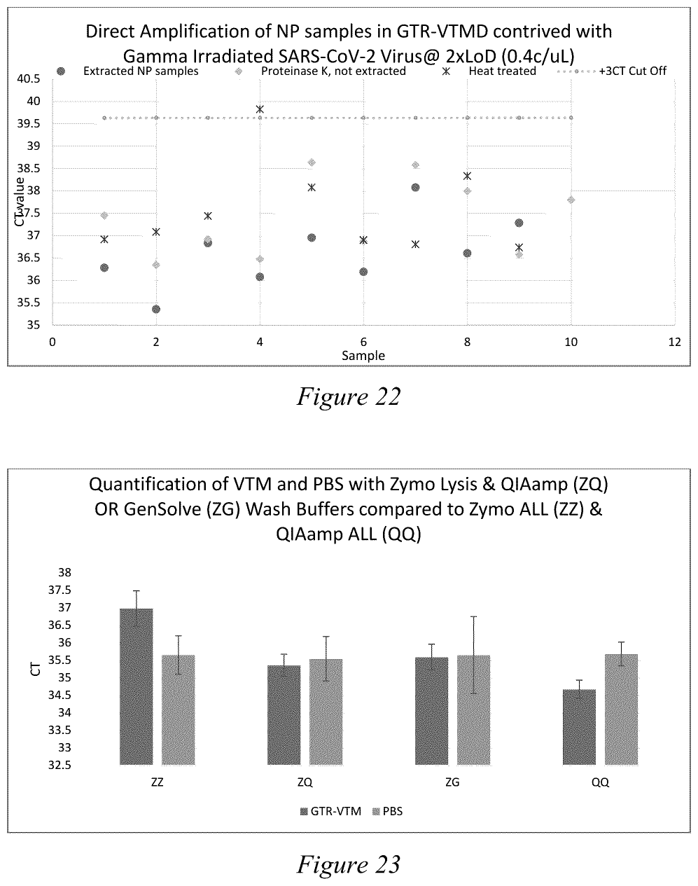

The results of this analysis are shown in FIG. 22. In FIG. 22 the “pass” criteria was >95% recovery as indicated by a CT cutoff. FIG. 22 shows that both Proteinase K and the heat-treated samples pass the criteria of greater than 95% positive recovery, although the heat treatment provided one failed sample (at an approximately 95% recovery).

### Example 9

To evaluate the efficacy and compatibility of Proteinase K, a direct-to-PCR transport media for saliva samples comprising Proteinase K (described as “GTR-STMDk”) was prepared according to Table 9.

TABLE 9
GTR-STMDk

| Component | Amount | Units |
|---|---|---|
| Mannitol | 29.3 | mg/mL |
| ATA | 0.06 | mg/mL |
| Proteinase K | 10 | mg/mL |

To manufacture the GTR-STMDk samples, 55 uL of GTR-STMDk solution was added to individual GTR-STMDk tubes and dried at 46° C. for 30 minutes. 1 mL of saliva contrived with 2 copies/uL of SARS-CoV-2 virus was added to the GTR-STMDk tubes. 100 uL of the saliva was prepared for direct to PCR by heating at 56° C. for 5 minutes followed by heating at 95° C. for 5 minutes. Matched control samples were also prepared, having SARS-CoV-2 viral RNA extracted from 100 uL of GTR-STMDk with QIAamp Viral RNA kit. 5 uL of the direct-to-PCR sample and matched extracted viral RNA respectively were quantified with rt-qPCR using TaqPath mix and CDC's N1 primer. The CT values for the direct-to-PCR and QIAamp extracted samples were determined. The results are shown in Table 10.

TABLE 10
CT Values for Direct-to-PCR and QIAamp Extracted Saliva Samples
Saliva spiked with Gamma Irradiated SARS-CoV-2 @2 c/uL sampled in GTR-STMdk

| Sample | CT value | | | | | | | | | | Average | Std Dev |
|---|---|---|---|---|---|---|---|---|---|---|---|---|
| Direct into PCR | 34.11 | 35.61 | 34.67 | 34.94 | 34.93 | 35.21 | 34.32 | 35.11 | 34.67 | 34.94 | 34.85 | 0.44 |
| QIAamp extracted | 34.49 | 34.60 | 35.23 | 34.43 | 34.71 | 34.13 | 34.61 | 34.02 | 34.50 | 34.23 | 34.49 | 0.34 |

Equivalent amounts of viral RNA was recovered from both the direct to PCR and QIAamp extracted samples. Table 10 therefore illustrates that the GTR-STMDk composition beneficially provides comparable recovery for both direct-to-PCR and extracted saliva samples.

### Example 10

GTR-STMDk direct-to-PCR samples were further compared to QIAamp extracted samples, and samples which were both direct and treated with QIAamp at varying LoDs. Samples were prepared by diluting the SARS-CoV-2 virus to 2×, 5×, and 10× LoD, wherein a 2× LoD=0.4 copies/uL, a 5× LoD=1 copy/uL, and a 10× LoD=2 copies/Ul. The SARS-Cov-2 virus was then added to the GTR-STMd composition. 3 uL of Proteinase K was added to 100 ul of GTR-STMd samples. The Proteinase K treated samples were then incubated at 56° C. for 5 minutes and heated at 95° C. for a further five minutes. For the samples which were not direct-to-PCR (control), the RNA was extracted. Specifically, RNA was extracted from 100 Ul with the QIAamp viral RNA following the CDC recommended protocol as described herein. 5 Ul of all samples, whether extracted or direct-to-PCR were then amplified using the N1 primer. The CT values were then determined. The results are shown in Table 11 and FIG. 25.

TABLE 11

| | CT (avg) | STD Dev |
|---|---|---|
| 10 × LOD Direct* | 35.44 | 0.57 |
| 10 × LoD Direct + QIAamp** | 34.88 | 1.74 |
| 10 × LOD QIAamp | 33.78 | 0.58 |
| 5 × LoD Direct | 36.25 | 0.72 |
| 5 × LoD Direct + QIAamp | 35.59 | 0.22 |
| 5 × LoD QIAamp | 35.12 | 0.15 |
| 2 × LOD Direct | 37.85 | 0.97 |
| 2 × LoD Direct + QIAamp | 36.55 | 0.31 |
| 2 × LOD QIAamp | 37.26 | 0.39 |

*Direct samples are treated with Proteinase K + heat;
**Direct + QIAamp are samples extracted With QIAamp viral RNA kit after Proteinase K + heat treatment.

As shown in FIG. 25, the direct-to-PCR samples prepared using the STMD Proteinase K treated media provided recovery comparable to the extracted samples, even at a very low concentration of the virus.

### Example 11

VTMD (liquid, direct-to-PCR) samples treated with Proteinase K (VTMDk) were compared to QIAamp extracted samples to assess relative recovery. VTMD solution was prepared as discussed in Example 7. The VTMD samples and QIAamp control samples were prepared according to the procedures of Example 10. The resulting CT values are shown in Table 12.

TABLE 12

| CT | NP Sample Treatment | CT | NP Sample Treatment |
|---|---|---|---|
| 36.28 | QIAamp viral RNA kit | 37.44905 | Direct into RT-qPCR after |
| 35.35 | Extracted samples | 36.7309 | Proteinase K treatment |
| 36.83 | | 36.91598 | |
| 36.07 | | 36.47499 | |
| 36.95 | | 38.6339 | |
| 36.19 | | 36.87534 | |
| 38.07 | | 38.57762 | |
| 36.6 | | 37.99012 | |
| 37.28 | | 36.57594 | |
| 36.63 | Average CT | 37.36 | Average CT |
| 0.784 | Standard Deviation | 0.85 | Standard Deviation |

As with Example 10, the results of Table 12 show that the direct-to-PCR samples prepared using the VTMD Proteinase K treated media provided recovery comparable to the extracted samples, even at a very low concentration of the virus.

### Example 12

The extraction efficiencies of the VTM media of Table 3A and the STM media of Table 5 were assessing using various paramagnetic and column-based extractions. Samples were prepared for extraction by first diluting gamma irradiated SARS-CoV-2 virus to 10×LoD (2 copies per μL) and adding the virus to a nasopharyngeal swab and 1 mL of the VTM media of Table 3. The samples were then vortexed, centrifuged, and pooled. The samples were then extracted using ZIAamp, GenSolve, or Zymo washes. Specifically, the first set of samples (“ZZ”) were prepared by using the Zymo extraction protocol to yield a 100 uL sample size. The samples were eluted with 100 μL. Next, water was added in place of beta-mercaptoethanol in the viral RNA buffer, and 4 μL of the carrier RNA (taken from the Qiagen kit) was added to 400 uL RNA buffer per sample. The next set of samples (“ZQ”) was the same as described for the “ZZ” samples except that the QIAamp washes 1 and 2 were used in place of the Zymo washes and ethanol. The samples were washed at 6k rcf. A further set of samples (“ZG”) was prepared the same as the “ZZ” samples except that washes of the instant application were used in place of Zymo washes and ethanol. The samples were washed at 6k rcf. Finally, a last set of samples (“QQ”) were used as a control, prepared using all QIAamp reagents. These samples were compared to a control PBS solution.

The results of this analysis are shown in FIG. 23. This Figure demonstrates that the SARS-CoV-2 extraction efficacy of AIAamp wash is better than that of the GenSolve wash, which is better than the Zymo wash for the VTM media spiked with gamma irradiated SARS-CoV-2 virus at 10×LoD.

Next, MagMax and Zymo were compared for their relative SARS-CoV-2 RNA extraction efficiencies on samples stabilized in STM media of Table 5 as compared to “neat” saliva” at 10×LoD. Specifically, STM media and neat saliva were extracted using the MagMax kit. 2 mL contrived saliva samples with gamma irradiated SARS-CoV-2 virus at 10× LoD (2 copies per 4). 1 mL of STM media was added to the sample and mixed for one minute. Each of the STM samples and neat saliva samples were extracted according to the MagMax protocol. 5 uL of extracted RNA were amplified with Taqpath mastermix. The samples were analyzed according to the following table:

TABLE 13
Comparison of MagMax vs. QIAamp for
STM and Neat Saliva at 10 × LoD Virus

| CT | Sample | CT | Sample |
|---|---|---|---|
| 31.6 | Saliva in | 31.3 | Neat Saliva |
| 31.6 | GTR-STM | 31.5 | |
| 31.4 | | 31.3 | |
| 31.5 | Average CT | 31.4 | Average CT |
| 0.09 | Std Dev | 0.08 | Std Dev |

Next, a comparison of Zymo and MagMax extraction protocols was run for both the VTM and the STM media. 2 mL of contrived saliva samples were prepared to a (2 copies per 4), 5×LoD 4 (1.5 copies per 4), and 2×LoD (0.4 copies per 4) with gamma irradiated SARS-CoV-2 virus. 1 mL of contrived saliva was added to the STM media of Tbl. 5 or the VTM media of Tbl. 3A and mixed for one minute. 200 μL of each of the STM, VTM and neat saliva were extracted following the Zymo protocol. 5 μL of the extracted RNA was amplified using TAqpath mastermix. Results for the extraction protocols are in Tbls. 13-14.

TABLE 14
Comparison of Zymo and MagMax Extraction Protocols for VTM Media

| | Gamma Irradiated SARS-CoV-2 virus | | | | | | | |
|---|---|---|---|---|---|---|---|---|
| | SALINE | | GTR-VTM | | SALINE | | GTR-VTM | |
| | CT | CT | CT | CT | Quant | Quant | Quant | Quant |
| Viral Load | mean | SD | mean | SD | Mean | SD | Mean | SD |

ZYMO EXTRACTION

| | | | | | | | | |
|---|---|---|---|---|---|---|---|---|
| 2× LoD | 35.79 | 0.51 | 35.98 | 0.57 | 8.72 | 3.66 | 7.83 | 3.66 |
| 5× LoD | 34.59 | 0.45 | 34.17 | 0.16 | 22.38 | 7.47 | 30.00 | 3.90 |
| 10× LoD | 33.48 | 0.31 | 33.17 | 0.17 | 53.05 | 12.73 | 66.95 | 8.57 |

MAGMAX EXTRACTION

| | | | | | | | | |
|---|---|---|---|---|---|---|---|---|
| 2× LoD | 35.25 | 0.44 | 35.57 | 0.26 | 45.80 | 13.70 | 35.35 | 6.39 |
| 5× LoD | 34.01 | 0.25 | 34.15 | 0.23 | 111.21 | 22.01 | 100.05 | 16.70 |
| 10× LoD | 33.86 | 0.27 | 33.70 | 0.33 | 124.50 | 23.66 | 141.50 | 33.21 |

TABLE 15
Comparison of Zymo and MagMax Extraction Protocols for STM Media
GTR-STM and Neat Saliva at 10× LoD (2 copies/uL)

| STM | | Saliva | | STM | | Saliva | |
|---|---|---|---|---|---|---|---|
| CT | CT | CT | CT | Quant | Quant | Quant | Quant |
| mean | SD | mean | SD | mean | SD | mean | SD |

Zymo viral Magbead

| | | | | | | | |
|---|---|---|---|---|---|---|---|
| 32.52 | 0.24 | 32.44 | 0.15 | 272.78 | 40.24 | 284.21 | 27.11 |
| 32.59 | 0.08 | 32.99 | 0.35 | 258.18 | 13.79 | 205.11 | 45.66 |

MagMax

| | | | | | | | |
|---|---|---|---|---|---|---|---|
| 32.39 | 0.19 | 32.47 | 0.08 | 294.05 | 33.79 | 277.82 | 15.00 |
| 33.02 | 0.53 | 32.67 | 0.20 | 205.29 | 62.50 | 246.38 | 30.53 |

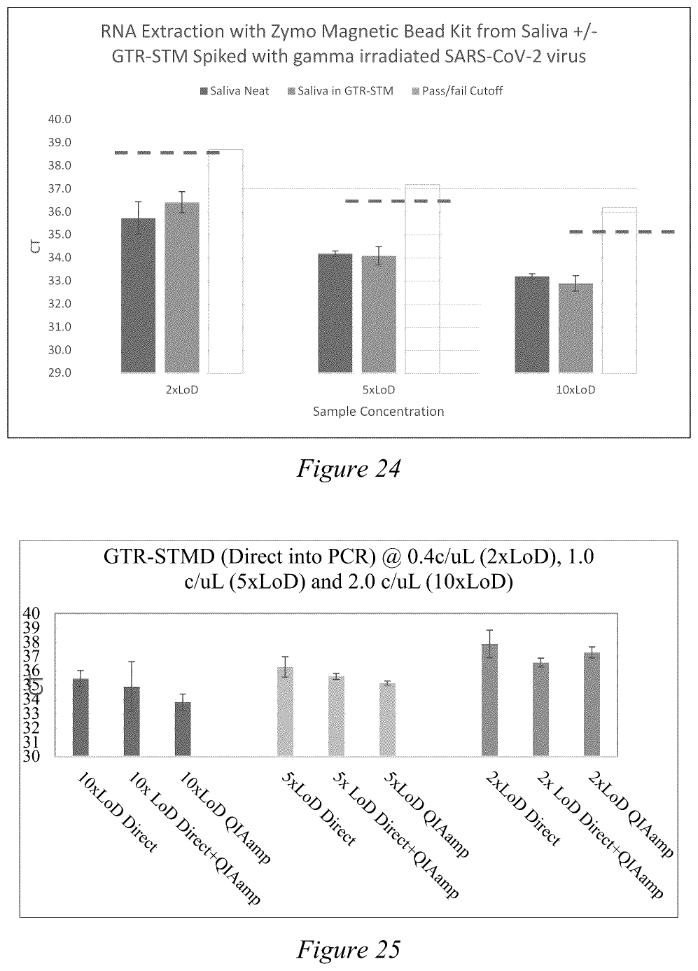

These results are further shown in FIG. 24. FIG. 24 shows that the saliva stabilized in the GTR-STM media provides comparable recovery to the neat saliva sample. Both types of samples provide recovery well below the pass/fail cutoff.

### Example 13

In addition to the testing described herein, the transport media were prepared as part of a point-of-care saliva collection device for direct-to-PCR amplification. Transport media was prepared according to Table 16.

TABLE 16
GTR-STMDk

| Component | Amount | Units |
|---|---|---|
| Mannitol | 29.3 | mg/mL |
| ATA | 0.06 | mg/mL |
| Proteinase K | 10 | mg/mL |

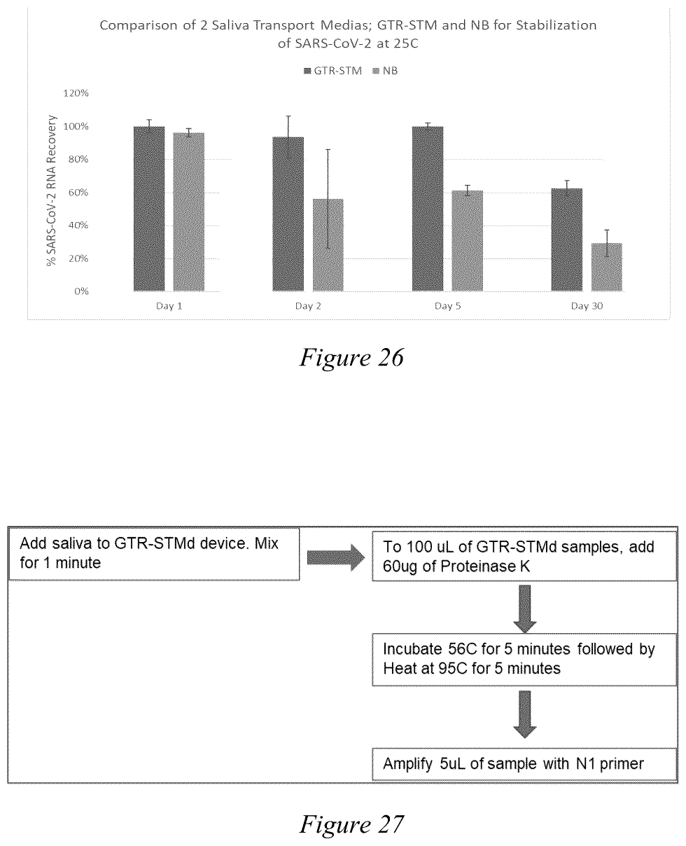

The efficacy of this media was compared to another commercially available saliva transport media. 1 mL of a contrived saliva sample with SARS-CoV-2 virus was added to the GTR-STM media of Table 16 and also to the comparative media, NB-STM. The GTR-STM saliva sample was mixed for one minute with the dried GTR-STM media in a saliva collection tube. The NB-STM RNA stabilizing solution provided with the saliva collection kit was added to the sample in the NB saliva tube. The GTR-STM and NB-STM saliva samples were stored at 25° C. and matched control samples were stored at −80° C. over a period of 30 days. SARS-CoV-2 RNA was extracted from all samples at intervals in the 30 day storage period. Specifically, RNA was extracted on days 1, 2, 5, and 30. The percentage of RNA recovery and impact on LoD were subsequently assessed. The results of the RNA recovery are shown in FIG. 26, while the impact on LoD is shown in Table 17.

As shown in FIG. 26, following five days of storage at 25° C., 100% of the SARS-CoV-2 RNA was recovered from the GTR-STM experimental samples (based on a baseline provided by the −80° C. GTR-STM controls). Greater than 60% of viral RNA was recovered after one month. In comparison, although the NB-STM media recovered 100% of the viral RNA on day 1, only 50% was recovered on days 2 and 5, and only 30% of the RNA was recovered after 30 days.

TABLE 17
Impact on Limit of Detection (LoD)

| | | Day 1 | Day 2 | Day 5 | Day 30 |
|---|---|---|---|---|---|
| Experimental | GTR-STM/ | 3.47 | 4.97 | 4.85 | 7.03 |
| | NB-STM | | | | |
| Control | GTR-STM/ | 2.90 | 2.98 | 2.78 | 3.29 |
| (−80° C.) | NB-STM | | | | |

Table 17 shows the ratio of GTR-STM extracted RNA amount compared to NB-STM. 3 to 4 times more RNA is quantified with saliva collected in non-dilutive GTR-STM compared to NB-STM. This is significant because although pooling of saliva samples dramatically increases the throughput and reduces the cost of COVID-19 testing, the dilution of the saliva with a secondary stabilization reagent will generally reduce the effectiveness of pooled testing as the dilution will soon overwhelm the LoD, making a positive undetectable even with as few as 4 pooled samples. Beneficially, a non-diluted saliva sample such as in GTR-STM will not increase the LoD thus making pooling possible. For example, if the viral load of the saliva sample is 1e5 viral copies/mL (100c/uL), the LoD for 5 pooled samples should be 20 copies/uL which is within the LoD for CDC's COVID-19 RT-qPCR assay.

### Example 14

The GTR-STMDk formula of Table 16 is a dry viral transport media for collection of saliva samples allowing the resulting modified oral fluid to be added directly to a molecular assay without RNA extraction. Preliminary data have shown that GTR-STMD stabilizes raw saliva samples for 1 day at ambient temperature and up to 4 days at 4° C. An example workflow for the direct-to-PCR process using the GTR-STMDk media of Table 16 is described below. This process is also depicted in FIG. 27.

Saliva collected in GTR-STMD can be added directly to RT-qPCR reaction mix after an initial enzymatic treatment to release the viral RNA. 60 ug of Proteinase K (20 mg/ml) was added to 100 uL of contrived saliva sample in GTR-STMD and heated to 56° C. for 5 minutes followed by inactivation of Proteinase K by heating at 95° C. for 5 minutes. 5 uL of this treated saliva was added to 15 uL of RT-qPCR reaction mix and amplified per the assay manufacturer's instructions, in this case, amplification using 5 uL of the sample with the N1 primer.

### Example 15

Further analysis was conducted on saliva collection media for SARS-CoV-2 for direct-to-PCR use. The key active components in the saliva collection media included 29.3 mg/mL mannitol and 60 pg Proteinase K. To produce the saliva collection media and assess its efficacy, a total volume of 55 uL of STMdk media according to Table 9 was added to various saliva transport tubes and dried at 46° C. for 2 hours. Next, between 50 μL and 1 mL of saliva was collected. The saliva was mixed with the STMdk composition for 1 minute. The STMdk/salive sample tube was heated at 95° C. for 5 minutes and then placed on ice for 5 minutes. 5 μL of saliva was added directly to 15 μL of PCR mix. Up to 33% of the total volume of the PCR reaction can be added as saliva sample.

### Example 16

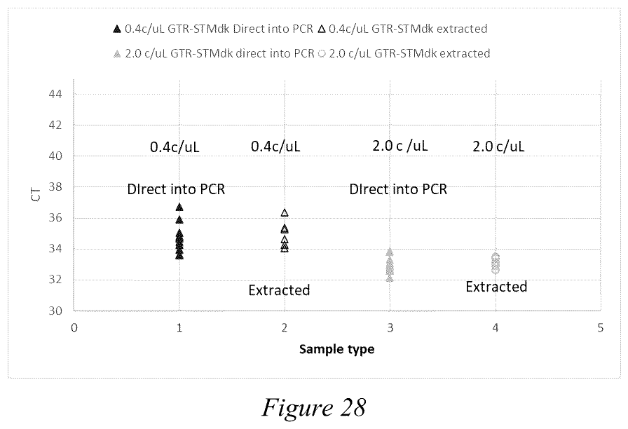

An assessment of the volume of media relative to the volume of saliva was conducted to determine whether any change in the CT values would be exhibited. 50 μL to 1 mL of saliva was contrived with 0.4 copies/μL (2×LoD) or 2 copies/μL (10×LoD) of SARS-CoV-2 added to GTR-STMdk media according to Table 9. For direct into PCR, 100 μL of GTR-STMdk media was heated to 95° C. for 5 minutes. The samples were placed at 4° C. for 5 minutes to bring to room temperature before adding to RT-PCR samples. Viral RNA extracted from matched GTR-STMdk samples were controls. 5 μL of GTR-STMdk and extracted viral RNA was amplified following CDC's EUA approved RT-PCR protocol. The results are shown in Table 18 and FIG. 28. As shown in Table 18, the difference in average CT values of the direct into PCR amplified product to the average CT value of the GTR-STMdk samples amplified after extraction of RNA from the GTR-STMdk samples spiked at 0.4c/μL (2×LoD) and 2c/μL (10×LoD) are similar.

TABLE 18
Saliva Volume Titration in GTR-STMdk
Volume Tolerance of STMdk saliva collection devices

| | | | | uL of | Copies |
|---|---|---|---|---|---|
| 50 | 100 | 500 | 1000 | Saliva | virus/uL |

10× LoD

| | | | | | | | |
|---|---|---|---|---|---|---|---|
| CT STMdk extracted | CT, STMdk ± Std Dev | 33.93 ± 0.16 | 32.68 ± 0.59 | 32.94 ± 0.16 | 32.71 ± 0.15 | 10× LoD | 2 |
| RNA: 33.17 ± 0.34 | CT Difference | 0.76 | −0.49 | −0.22 | −0.45 | | |
| | (Direct PCR) − (Extracted) | | | | | | |

2× LoD

| | | | | | | | |
|---|---|---|---|---|---|---|---|
| CT STMdk extracted | CT, STMdk ± Std Dev | 34.41 ± 0.58 | 34.86 ± 0.93 | 33.885 ± 0.49 | 35.36 ± 1.16 | 2× LoD | 0.4 |
| RNA: 34.98 ± 0.84 | CT Difference | −0.57 | −0.11 | −1.10 | 0.38 | | |
| | (Direct PCR) − (Extracted) | | | | | | |

Each data point in FIG. 28 is a compilation of all volumes of saliva from 50 μL to 1 mL in GTR-STMdk. The CT values for the 2×LoD samples is spread over 3 CT's for both the GTR-STMdk samples added direct into PCR and matched samples of viral RNA extracted from GTR-STMdk sample with QIAamp viral RNA kit. The spread in CT values for the 10×LoD samples is approximately 2CT values for the direct into PCR and GTR-STMdk samples amplified after extraction of RNA with QIAamp viral RNA kit.

Next, saliva samples spiked at 0.4 copies/μL of SARS-CoV-2 virus added to GTR-STMdk were added to RT-PCR master mix at 5 μL (33%) and 3.75 μL (27%) of sample in 10 μL of master mix for a total reaction volume of 15 μL, and at 5 μL(25%) of sample to 15 μL, of master mix for a total reaction volume of 20 μL. Matched purified RNA samples from the same sample were also added to the same volume of RT-PCR master mix. Six replicates of each sample type were amplified. The results are shown in Table 19. As shown in this Table, no inhibition of the direct into RT-PCR reaction when either 25%, 27% and 33% of GTR-STMdk samples are added directly into RT-PCR reaction.

TABLE 19
Titration of GTR-STMdk Saliva Sample Direct into RT-PCR

| | ul sample | ul Mmix | 1 | 2 | 3 | 4 | 5 | 6 | Average | Std Dev |
|---|---|---|---|---|---|---|---|---|---|---|
| Direct into PCR | 5.00 | 10.00 | 34.06 | 34.17 | 34.67 | 34.38 | 34.24 | 33.81 | 34.22 | 0.29 |
| Matched Extracted RNA | 5.00 | 10.00 | 34.24 | 33.47 | 34.97 | 34.15 | 33.68 | 34.47 | 34.16 | 0.54 |
| (CT, Direct PCR) − (CT, Extracted) | | | −0.17 | 0.70 | −0.30 | 0.22 | 0.56 | −0.66 | 0.06 | |
| Direct into PCR | 3.75 | 10.00 | 34.90 | 34.18 | 33.95 | 34.14 | 34.00 | 34.48 | 34.27 | 0.36 |
| Matched Extracted RNA | 3.75 | 10.00 | 33.82 | 33.51 | 35.06 | 34.38 | 34.11 | 34.20 | 34.18 | 0.53 |
| (CT, Direct PCR) − (CT, Extracted) | | | 1.09 | 0.67 | −1.11 | −0.24 | −0.11 | 0.28 | 0.10 | |
| Direct into PCR | 5.00 | 15.00 | 34.94 | 33.86 | 33.83 | 33.63 | 34.29 | 34.64 | 34.20 | 0.51 |
| Matched Extracted RNA | 5.00 | 15.00 | 33.47 | 33.58 | 34.47 | 33.55 | 33.53 | 33.58 | 33.70 | 0.38 |

| | | | | | | | |
|---|---|---|---|---|---|---|---|
| (CT, Direct PCR) − (CT, Extracted) | 1.47 | 0.28 | −0.63 | 0.07 | 0.76 | 1.07 | 0.50 |

The inventions being thus described, it will be obvious that the same may be varied in many ways. Such variations are not to be regarded as a departure from the spirit and scope of the inventions and all such modifications are intended to be included within the scope of the following claims.

The above specification provides a description of the manufacture and use of the disclosed compositions and methods. Since many embodiments can be made without departing from the spirit and scope of the invention, the invention resides in the claims.

What is claimed is:

1. A biological transport media comprising:
a pH adjuster;
one or more hydroxyl radical scavengers;
a metal chelator;
a reducing agent;
an inhibitor;
a stabilizer;
an antimicrobial agent; wherein the biological transport media is borate-free.

2. The biological transport media of claim 1, wherein the pH adjuster is lithium hydroxide, lithium dodecyl sulfate, lithium chloride, benzylidene rhodanine, sulfosalicylic acid, citric acid, tartaric acid, malic acid, sulfosalicylic acid, sulfoisophthalic acid, oxalic acid, borate, CAPS (3-(cyclohexylamino)-1-propanesulfonic acid), CAPSO (3-(cyclohexylamino)-2-hydroxy-1-propanesulfonic acid), EPPS (4-(2-hydroxyethyl)-1-piperazinepropanesulfonic acid), HEPES (4-(2-hydroxyethyl)piperazine-1-ethanesulfonic acid), MES (2-(N-morpholino)ethanesulfonic acid), MOPS (3-(N-morpholino)propanesulfonic acid), MOPSO (3-morpholino-2-hydroxypropanesulfonic acid), PIPES (1,4-piperazinediethanesulfonic acid), TAPS (N[tris(hydroxymethyl)methyl]-3-aminopropanesulfonic acid), TAPSO (2-hydroxy-3-[tris(hydroxymethyl)methylamino]-1-propanesulfonic acid), TES (N-[tris(hydroxymethyl)methyl]-2-aminoethanesulfonic acid), bicine (N,N-bis(2-hydroxyethyl)glycine), tricine (N-[tris(hydroxymethyl)methyl]glycine), tris (tris(hydroxymethyl)aminomethane), bis-tris (2-[bis(2-hydroxyethyl)amino]-2-(hydroxymethyl)-1,3-propanediol), 5-(4-dimethyl)amino benzylidene rhodanine, or a combination thereof.

3. The biological transport media of claim 2, wherein the hydroxyl radical scavenger is mannitol, erythritol, sorbitol, xylitol, azide, cysteine, lithium dodecyl sulfate, dimethylsulfoxide, histidine, salicylic acid, salicylate, monosaccharides, disaccharides, or a combination thereof.

4. The biological transport media of claim 3, wherein the inhibitor is aurintricarboxylic acid, boric acid, citric acid, salicylic acid, 1,2-bis(o-aminophenoxy)ethane-N,N,N′,N′-tetraacetic acid (BAPTA), diethylene triamine pentaacetic acid (DTPA), ethylenediaminetetraacetic acid (EDTA), ethylene glycol tetraacetic acid (EGTA), glycoletherdiaminetetraacetic acid (GEDTA), N-(2-hydroxyethyl)ethylenediamine-N,N′,N′-triacetic acid (HEDTA), nitrilotriacetic acid (NTA), 2,2′-bipyridine, o-phenanthroline, triethanolamine, or a combination thereof.

5. The biological transport media of claim 4, wherein the metal chelator is boric acid, aurintricarboxylic acid (ATA), borate, citric acid, citrate, salicylic acid, salicylate, 1,2-bis(o-aminophenoxy)ethane-N,N,N′,N′-tetraacetic acid (BAPTA), diethylene triamine pentaacetic acid (DTPA), ethylenediaminetetraacetic acid (EDTA), ethylene glycol tetraacetic acid (EGTA), glycoletherdiaminetetraacetic acid (GEDTA), N-(2-hydroxyethyl)ethylenediamine-N,N′,N′-triacetic acid (HEDTA), nitrilotriacetic acid (NTA), 2,2′-bipyridine, o-phenanthroline, triethanolamine, or a combination thereof.

6. The biological transport media of claim 5, wherein the reducing agent is EDTA, EGTA, o-phenanthroline, dithionite, dithioerythritol, dithiothreitol (DTT), dysteine, 2-mercaptoethanol, mercaptoethylene, bisulfate, sodium metabisulfite, pyrosulfite, pentaerythritol, thioglycolic acid, citrate, urea, uric acid, vitamin C, vitamin E, superoxide dismutases, or a combination thereof.

7. The biological transport media of claim 6, wherein the stabilizer is polyethylene glycol.

8. The biological transport media of claim 6, wherein the antimicrobial agent is penicillin, cephalosporin, ampicillin, amoxycillin, aztreonam, clavulanic acid, imipenem, streptomycin, gentamycin, vancomycin, clindamycin, polymyxin, erythromycin, bacitracin, amphotericin, nystatin, rifampicin, tetracycline, chlortetracycline, doxycycline, chloramphenicol, ammolfine, butenafine, naftifine, terbinafine, ketoconazole, fluconazole, elubiol, econazole, econaxole, itraconazole, isoconazole, imidazole, miconazole, sulconazole, clotrimazole, enilconazole, oxiconazole, tioconazole, terconazole, butoconazole, thiabendazole, voriconazole, saperconazole, sertaconazole, fenticonazole, posaconazole, bifonazole, flutrimazole, nystatin, pimaricin, amphotericin B, flucytosine, natamycin, tolnaftate, mafenide, dapsone, caspofungin, actofunicone, griseofulvin, potassium iodide, Gentian Violet, ciclopirox, ciclopirox olamine, haloprogin, silver sulfadiazine, undecylenate, undecylenic acid, undecylenic alkanolamide, Carbol-Fuchsin, nevirapine, delavirdine, efavirenz, saquinavir, ritonavir, indinavir, nelfinavir, amprenavir, zidovudine (AZT), stavudine (d4T), larnivudine (3TC), didanosine (DDI), zalcitabine (ddC), abacavir, acyclovir, penciclovir, valacyclovir, ganciclovir, rutin, tannic acid, Direct Red 80, or a combination thereof.

9. The biological transport media of claim 1, wherein the media is a solid or a liquid.

10. The biological transport media of claim 8, wherein the media comprises about 1-10% of the pH adjuster, about 15-35% of the one or more hydroxyl radical scavengers, about 5-25% of the metal chelator, about 15-30% of the reducing agent, about 0.1-5% of the inhibitor, about 35-55% of the stabilizer, and about 0.5-10% of the antimicrobial agent.

11. The biological transport media of claim 10, further comprising a serine protease.

12. The biological transport media of claim 11, wherein the serine protease is Proteinase k.

13. A method of storing a biological sample comprising:
adding the biological sample to the biological transport media of claim 10.

14. The method of claim 13, wherein the biological sample is whole blood, plasma, nasopharyngeal secretion, saliva, fecal matter, or sputum.

15. The method of claim 14, wherein the biological sample is when a liquid added to the biological transport media and is dried on the biological transport media.

16. A method of manufacturing the biological transport media of claim 10, the method comprising:
preparing a first solution comprising a pH buffer, a first hydroxyl radical scavenger, a second hydroxyl radical scavenger, a metal chelator, a reducing agent, an inhibitor, and a stabilizer;
preparing a second solution comprising an antimicrobial agent and a third hydroxyl radical scavenger;
combining the first solution and the second solution.

17. A biological sample collection kit comprising:
a sample carrier; and
a transport media comprising a hydroxyl radical scavenger and/or an oxygen radical scavenger; a metal chelator; and a serine protease; wherein the transport media is borate-free.

18. The biological sample collection kit of claim 17, wherein the hydroxyl radical scavenger and/or oxygen radical scavenger is mannitol, erythritol, sorbitol, xylitol, azide, cysteine, lithium dodecyl sulfate, dimethylsulfoxide, histidine, salicylic acid, salicylate, monosaccharides, disaccharides, or a combination thereof.

19. The biological sample collection kit of claim 18, wherein the metal chelator is boric acid, aurintricarboxylic acid (ATA), borate, citric acid, citrate, salicylic acid, salicylate, 1,2-bis(o-aminophenoxy)ethane-N,N,N′,N′-tetraacetic acid (BAPTA), diethylene triamine pentaacetic acid (DTPA), ethylenediaminetetraacetic acid (EDTA), ethylene glycol tetraacetic acid (EGTA), glycoletherdiaminetetraacetic acid (GEDTA), N-(2-hydroxyethyl)ethylenediamine-N,N′,N′-triacetic acid (HEDTA), nitrilotriacetic acid (NTA), 2,2′-bipyridine, o-phenanthroline, triethanolamine, or a combination thereof; and wherein the serine protease is Proteinase k.

20. The biological sample collection kit of claim 19, wherein the sample carrier is a saliva collection tube, a vial, a collection cup, a corrugated jar, a container jar, a collection tube, an absorbent pouch, and/or a collection tube comprising a swab.
